(19) United States
(12) Patent Application Publication
(10) Pub. No.: US 2023/0238231 A1
(43) Pub. Date: Jul. 27, 2023

(54) INTEGRATED MICROFLUIDIC PROBE (iMFP) AND METHODS OF USE THEREOF

(71) Applicant: Purdue Research Foundation, West Lafayette, IN (US)

(72) Inventors: Julia Laskin, West Lafayette, IN (US); Xiangtang Li, West Lafayette, IN (US)

(21) Appl. No.: 17/976,967

(22) Filed: Oct. 31, 2022

Related U.S. Application Data
(63) Continuation-in-part of application No. 17/609,114, filed on Nov. 5, 2021.
(60) Provisional application No. 62/855,422, filed on May 31, 2019.

(51) Int. Cl. H01J 49/04; H01J 49/00

(52) U.S. Cl. CPC H01J 49/0445; H01J 49/0004

(57) ABSTRACT

The microfluidic probe is configured for nano spray desorption electro spray ionization (nano-DESI) with fixed positioning of the channels therein for consistent and stable formation of a liquid bridge for nano-DESI and mass spectrometry imaging (MSI). The microfluidic probe may incorporate a shear force probe for sensing and maintaining a desired distance between the probe and the sample surface being analyzed. The microfluidic probe includes a primary solvent channel and a spray channel intersecting at a fixed orientation relative to each other at an opening in a tip of the probe. The microfluidic probe is constructed from a plastic material.

### CROSS REFERENCE TO RELATED APPLICATIONS

The present application is a continuation-in-part application which claims the benefit of 35 U.S.C. National Phase application Ser. No. 17/609,114, filed on Nov. 5, 2021, which in turn claims the benefit of PCT Application Serial No. PCT/US2020/034138, filed on May 22, 2020, which in turn claims the benefit of U.S. provisional application Ser. No. 62/855,422, filed May 31, 2019, the content of each of which are incorporated by reference herein in its entirety.

### GOVERNMENT INTEREST

The invention was made with U.S. government support under contract numbers HL145593 and CA255132 awarded by the National Institutes of Health. The U.S. government has certain rights in the invention.

### FIELD

The present disclosure generally relates to an integrated microfluidic probe (iMFP) and methods of use thereof.

### INTRODUCTION

This section provides background information related to the present disclosure which is not necessarily prior art.

Mass spectrometry imaging (MSI) is capable of providing comprehensive information on the distribution of multiple endogenous and exogenous molecules within animal tissues (van Hove E R A, Smith D F, & Heeren R M A (2010), J. Chromatogr. A 1217(25):3946-3954; Watrous J D, Alexandrov T, & Dorrestein P C (2011), Journal of Mass Spectrometry 46(2):209-222). MSI is able to map drugs, metabolites, lipids, peptides and proteins in thin tissue sections with high specificity and without the need of fluorescent or radioactive labeling. (Schwamborn K & Caprioli R M (2010), Mol. Oneal. 4(6):529-538; and Chughtai K & Heeren R M A (2010), Chem. Rev. 110(5):3237-3277).

Of the several MSI techniques (Alberici R M, et al. (2010), Analytical and Bioanalytical Chemistry 398(1):265-294), ambient ionization techniques such as desorption electrospray ionization mass spectrometry (DESI-MS) have been rapidly emerging and have the advantage of being performed at atmospheric pressure without the need for sample preparation (Ifa D R, Wu C P, Ouyang Z, & Cooks R G (2010), Analyst 135(4):669-681).

One particularly useful ambient ionization technique is nanospray desorption electrospray ionization (nano-DESI). This technique is a liquid extraction-based ionization technique that uses a solvent bridge formed between two capillaries and the analysis surface to desorb analytes. Nano-DESI has been used for imaging and quantification of molecules in biological samples with a spatial resolution of better than 10 microns. See, P. J. Roach, J. Laskin, A. Laskin “Nanospray Desorption Electrospray Ionization Mass Spectrometry”, Analyst, 135, 2233-2236 (2010); I. Lanekoff, M. Thomas, J. P. Carson, J. N. Smith, C. Timchalk, J. Laskin “Imaging of Nicotine in Rat Brain Tissue Using Nanospray Desorption Electrospray Ionization Mass Spectrometry”, Anal. Chem., 85, 882-889 (2013); I. Lanekoff, 0. Geydebrekht, G. E. Pinchuk, J. Laskin “Spatially-Resolved Analysis of Glycolipids and Metabolites in Living Synechococcus sp. PCC 7002 Using Nanospray Desorption Electrospray Ionization”, Analyst, 138, 1971-1978 (2013); I. Lanekoff, M. Thomas, J. Laskin “Shotgun approach for quantitative imaging of phospholipids using nanospray desorption electrospray ionization mass spectrometry”, Anal. Chem., 86, 1872-1880 (2014); R. Yin, K. E. Burnum-Johnson, X. Sun, S. K. Dey, J. Laskin “High Spatial Resolution Imaging of Biological Tissues Using Nano spray Desorption Electrospray Ionization Mass Spectrometry”, Nat. Protocols 14, 3445-3470 (2019); the content of each of which is incorporated herein by reference.

However, nano-DESI imaging with high spatial resolution approach is still challenging. For example, high-resolution nano-DESI MSI experiments rely on a manual positioning of finely-pulled fused silica capillaries relative to each other, the substrate, and the instrument inlet, which is a tedious process and relies heavily on researcher skill. Accordingly, although nano-DESI allows for quantitative imaging of hundreds of molecules with high spatial resolution which is currently unsurpassed by other techniques, the throughput is limited and the level of user involvement is high.

Accordingly, there is a continuing need for a microfluidic probe may be fabricated more economically. Desirably, the microfluidic probe would also be capable of mapping biomolecules in biological samples with a subcellular resolution.

### SUMMARY

In concordance with the instant disclosure, a microfluidic probe that may be more efficiently and economically manufactured, has been surprisingly discovered. Desirably, the microfluidic probe may also be used for mapping biomolecules in biological samples with a subcellular resolution

The present disclosure provides an integrated microfluidic probe for nano-DESI MSI experiments, also referred to herein as an integrated microfluidic probe (iMFP). The device integrates the primary and spray channels such that the relative positioning of those channels is fixed. Accordingly, an ideal relationship for iMFP MSI is maintained without the need for intensive user set-up. The probe can include an integrated shear force probe through, for example, the integration of piezoelectric devices in order to maintain the ideal position of the tip relative to the substrate being imaged during translation of the probe across the substrate surface. Accordingly, the probe can maintain an ideal relationship between the primary channel, the spray, channel, and the substrate surface throughout the MSI process without the need for time-intensive set-up allowing for increased throughput and higher quality and more consistent results than existing iMFP MSI approaches. The iMFP MSI probe described herein provides quantitative imaging with high spatial resolution of better than 20 μm with high sensitivity thereby increasing the feasibility of MSI analysis in more settings.

As in standard iMFP MSI devices, the spray channel can end in a spray tip directed to a mass spectrometer inlet located away from the substrate/probe interface. A stage on which the sample substrate is located, the probe, or both may be moveable to facilitate scanning of the sample with the probe in a plane along the sample's surface and to accommodate surface irregularities in the sample. Systems and methods of the present disclosure allow for the examination of biological and environmental samples without special sample pretreatment as required in MALDI. The probe integrates the primary and secondary capillaries used in iMFP into a single device. An integrated shear force feedback system can be used to precisely control the distance to the sample surface to enable imaging with high spatial resolution. The integrated channels meet at a fixed orientation at the tip of the iMFP probe operable to produce a small liquid bridge of flowing solvent between the primary channel and the spray channel. The liquid bridge extracts molecules from the sample surface as it passes into the spray channel and is directed to the nanospray emitter to be sprayed into the mass spectrometer inlet.

The presently disclosed nano-DESI probe can be used for high-throughput two- and three-dimensional quantitative mapping of molecules on surfaces and provides a useful tool for drug discovery, biological, environmental, and clinical research by increasing throughput, resolution, and consistency over existing iMFP techniques.

The integrated microfluidic nano-DESI probe combines microfluidic surface sampling with electrospray ionization and shear force measurement. Because glass is considered the best material in terms of its compatibility with soft ionization techniques, the probe can preferably be monolithically fabricated on a glass microchip. Other materials may also be used including semiconductors such as silicon wafer or polymers such as silicones or thermoplastics. The size of the liquid bridge can be controlled by the size of the channels forming the liquid bridge, the angle between the channels, and the flow rate of the solvent through the probe. Molecules dissolved from the sample into the liquid bridge are efficiently transferred by the flowing solvent to a mass spectrometer inlet and ionized by electrospray ionization. The combination of these approaches allows for high-throughput and high-resolution quantitative imaging of biomolecules in biological samples including tissue sections. In particular, the microfluidic nano-DESI probe systems and methods described herein offer the advantages of robustness, sensitivity, and ease of use, which make the technique attractive for a broad range of applications.

iMFP MSI using systems and methods of the present disclosure allows for the extraction of lipid species (e.g., phosphatidylcholine (PC), lysophosphatidylcholine (LPC) and sphingomyelin (SM)) from tissue without disturbing the tissue sample morphology. Accordingly, subsequent analysis can be performed on the same tissue section, which is particularly valuable for multimodal imaging or where the sample is limited or hard to obtain. Systems and methods of the present disclosure allow for iMFP-MS imaging of any type of sample, for example, human or animal tissue, skin, plant tissue and seeds, living microbial, yeast, or fungal colonies, soil, environmental samples, rocks, industrial chemical mixtures, and cleaning materials. In certain embodiments, the sample is human tissue. The human tissue may be lung, kidney, brain, liver, muscle, pancreatic tissue, healthy or diseased, such as cancerous bladder, kidney and prostate tissue. In these embodiments, iMFP MSI may be performed on the tissue to obtain a molecular diagnosis and then the same tissue section can be used not only for H&E staining, but also for immunohistochemistry. These advancements allow nano-DESI-MS imaging to be included in the tissue analysis clinical workflow. They also allow more detailed diagnostic information to be obtained by combining two orthogonal techniques, imaging MS and histological examination.

Operated in an imaging mode, systems and methods of the present disclosure can use a standard microprobe imaging procedure, which in this case involves continuously moving the sample under the integrated probe while recording mass spectra. Each pixel yields a mass spectrum, which can then be compiled to create an image showing the spatial distribution of a particular compound or compounds. Such an image allows one to visualize the differences in the distribution of particular compounds over the lipid containing sample (e.g., a tissue section). The spatial resolution obtained using systems and methods of the present disclosure can be 20 μm or better.

If independent information on biological properties of the sample are available, then the MS spatial distribution can provide chemical correlations with biological function or morphology.

In particular embodiments, the nano-DESI ion source is a source configured as described in Yin et al. (R. Yin, K. E. Burnum-Johnson, X. Sun, S. K. Dey, J. Laskin “High Spatial Resolution Imaging of Biological Tissues Using Nanospray Desorption Electrospray Ionization Mass Spectrometry”, Nat. Protocols 14, 3445-3470 (2019)), incorporated by reference herein. A custom software program, MSI QuickView (M. Thomas, B. S. Heath, J. Laskin, D. Li, A. P. Kuprat, K. Kleese van Dam, J. P. Carson, “Visualization of High Resolution Spatial Mass Spectrometric Data during Acquisition.” In 34th Annual International Conference of the IEEE Engineering in Medicine and Biology Society, 5545-48 (2012), incorporated herein by reference), allows the conversion of the XCalibur 2.0 mass spectra files (.raw) into 2D ion images.

Methods of the present disclosure can involve using a solvent or liquid phase that does not destroy native tissue morphology. Any liquid phase compatible with mass spectrometry may be used with methods of the present disclosure. Exemplary liquid phases include methanol (MeOH), ethanol (EtOH), water, acetonitrile (ACN), dichloromethane (DCM), DMF, and mixtures of thereof. Acids (formic, acetic, TFA, and other), salts (NaCl, KCl, AgNO3, NaCH3COO), and other reagents may be added to the solvent and it may be buffered. In certain embodiments, the liquid phase is DMF. In certain embodiments, 9:1 MeOH:H2O is used as a solvent. Other exemplary liquid phases include MeOH:ACN:Toluene, MeOH:CHCb, and ACN:CHCb.

In certain aspects, systems of the present disclosure can include a probe (optionally comprised of non-porous material). Probes may comprise a primary channel and a spray channel intersecting at a fixed orientation relative to each other at an opening in a tip of the probe. The probe can be operable to create a liquid bridge at the opening between the primary channel, the spray channel, and a surface when the opening is located proximal to the surface and a liquid is flowed through the primary channel into the spray channel across the opening. Probes may include a nanospray emitter in fluid communication with the opening via the spray channel. Probes may further include a make-up solvent channel.

Systems may further include a sensor operable to sense displacement of the tip of the probe perpendicular to the surface as the probe translates across the surface. Systems may further comprise an agitator operable to move the tip of the probe perpendicularly relative to the surface as the probe translates across the surface, a sensor connected to a lock-in amplifier, and a computer comprising a non-transitory tangible memory and a processor in communication with lock-in amplifier and XYZ stage holding the sample surface. In certain embodiments, systems of the present disclosure also include one or more sensors (such as optical sensors) for sensing distance. The computer uses the amplitude of the probe vibration detected by the lock-in amplifier and maintains it at a set value by changing the distance between the sample and the probe. Other means of measuring the distance between the sample and the probe may include confocal chromatic sensing, optical interferometry, optical coherence tomography, acoustic, electrochemical or contact profilometry employed either off-line or directly linked to the nano-DESI probe.

In certain embodiments, systems may include a stage operable to locate the surface relative to the probe opening and liquid bridge. The stage can be movable and in communication with the computer which is operable to move the stage relative to the opening. An electrode may be operably coupled to the probe and an ion analysis device that comprises a mass analyzer may be included in the system wherein the system can be configured such that the probe is at atmospheric pressure, the mass analyzer is under vacuum, and the nanospray emitter points in a direction of an inlet of the mass analyzer or another ion analysis device such that charged droplets produced at the tip of the probe are transferred into the inlet of the ion analysis device and converted into bare ions through solvent evaporation.

A solvent delivery device may be included that is operably coupled to the probe such that solvent from the solvent delivery device is supplied to the tip of the probe via the primary channel. The fixed orientation of the primary channel and the spray channel at the opening can form a triangle where the distance between the meeting point of the two channels in the device and the opening of the probe (the side that contacts the sample) are the same or close to the width of the channel to ensure sensitive detection and stable signal from the sample. The spray channel's cross-sectional width or depth and the primary channel's cross-sectional width or depth may be approximately equal. In various embodiments, the triangle's height can be approximately equal to the cross-sectional width or depth of the spray channel and the primary channel. The spray channel may be about 1 μm to about 300 min cross-sectional width or depth. The opening can be from about 1 μm to about 600 μm wide. The non-porous material can be glass or other suitable material. The probe may further comprise a makeup solvent channel in fluid communication with the spray channel at a point between the opening and the nanospray emitter. In other configurations, a plurality of interconnected channels may be used to enable online cleanup, separation, or derivatization of the extracted species

Further areas of applicability will become apparent from the description provided herein. It should be understood that the description and specific examples are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 shows a prior art nano-DESI configuration.

FIG. 2 shows a prior art nano-DESI configuration featuring shear force microscopy.

FIG. 3 shows an exemplary layout of primary and spray channels in a nano-DESI probe.

FIG. 4 shows an exemplary nano-DESI probe with integrated primary and spray channels and shear force sensor.

FIG. 5 shows exemplary photomasks used to fabricate nano-DESI probes.

FIG. 6 shows layers used in fabricating a glass microfluidic nano-DESI probe according to certain embodiments.

FIG. 7 shows primary and spray channels during construction of a nano-DESI probe. FIG. 8 plots channel depth of the spray channels shown in FIG. 7;

FIG. 9 shows an exemplary nano-DESI probe formed of glass;

FIG. 10 shows a nanospray emitter of a nano-DESI probe positioned near a mass spectrometer inlet;

FIG. 11 diagrams a preferred orientation of the primary and spray channels within a nano-DESI probe;

FIG. 12 shows excitation spectra acquired with the probe kept in the air and positioned on the glass surface as well as the difference between the two;

FIG. 13 shows an approach curve acquired at an optimized frequency of 137.0 kHz showing the amplitude of the shear force probe vibration as a function of the distance between the probe and sample surface.

FIG. 14 panels A-B show performance evaluation of the iMFP, (Panel A) Ion chronogram of the internal standard (LPC 19:0) signal from continuous monitoring for around one hour, the signal is normalized to the total ion current (TIC). In this experiment, the iMFP is brought in contact with the surface of a glass slide and the signal of the standard at m/z 560.37 is measured as a function of time; (Panel B) A single-pixel positive mode nano-DESI spectrum of a mouse uterine tissue showing SIN of ˜90 for the most abundant lipid peak.

FIG. 15 shows a mass spectrum obtained for a single pixel of an image obtained using the nano-DESI probe;

FIG. 16 panels A-B Representative positive ion images of [M+Na]+ ions of molecules in mouse uterine tissues obtained using iMFP (Panel A) and capillary-based nano-DESI probe (Panel B). Scale bar: 1 mm; the intensity scale: black (low), yellow (high).

FIG. 17 representative positive ion images of [M+Na]+ ions of phospholipids obtained in mouse uterine tissue sections using the iMFP. The experimental conditions are as follows: scan rate of 20 μmis, solvent flow rate of 1.0 μL/min, spray voltage of 3000 V, and a distance from the emitter tip to the mass spectrometer inlet of ˜0.5 mm.

FIG. 18 is a picture illustrating various components and their arrangement in a miniature mass spectrometer.

FIG. 19 shows a high-level diagram of the components of an exemplary data-processing system for analyzing data and performing other analyses described herein, and related components.

FIG. 20 shows different images associated with an integrated microfluidic probe (iMFP).

FIG. 21 panels A-D show estimating the spatial resolution of the iMFP: (Panel A) An ion image of SM 34:1 in the mouse uterine tissue section; a white line indicates the location of the line profile shown in panel B. (Panel B) A representative line profile of SM34:1 along the white line in panel A. The ion signal is normalized to the TIC. (Panel C) An expanded view of the boundary region between GE, LE, and stroma. (Panel D) A partial line profile extracted along the white line shown in panel C. The spatial resolution ranges from 22 to 25 μm. Arrows indicate the maximum (100%) and minimum (0%) values; Dashed lines indicate the positions at which the SM 34:1 signal is at 20% and 80% of its minimum and maximum value, respectively, for a specific region.

FIG. 22 panels A-F show representative positive ion images of [M+Na]+ ions of phospholipids in mouse brain tissue acquired using the iMFP. (Panel A) Optical image of the mouse brain. Ion images of (Panel B) the internal standard, LPC19:0, at m/z 560.3525; (Panel C) PC36:2 at m/z 808.5812; (Panel D) LPC16:0 at m/z 518.3205; (Panel E) PC 34:0 at m/z 784.5747; (Panel F) PC34:1 at m/z 782.5657. Scale bar: 2 mm; total area analyzed in this experiment: 7.7 mm×5.5 mm.

FIG. 23 panel A diagrams a preferred orientation of the primary solvent and spray channels within a nano-DESI probe.

FIG. 23 panel B is an enlarged view of the nano-DESI probe, as shown in FIG. 23 panel A, further depicting a liquid bridge at an opening between the primary solvent channel, the spray channel, and a surface when the opening is located proximal to the surface and a liquid is flowed through the primary channel into the spray channel across the opening.

FIG. 23 panel C illustrates a preferred orientation of a nanospray emitter disposed adjacent to a mass spectrometer inlet.

FIG. 24 illustrates a method of fabricating a plastic microfluidic probe via wire imprinting.

FIG. 25A diagrams a fabricating method for manufacturing a plurality of plastic microfluidic probes with a single thermoplastic sheet, further depicting a template being created.

FIG. 25B illustrates the fabricating method for manufacturing a plurality of plastic microfluidic probes with a single thermoplastic sheet, as shown in FIG. 25A, further depicting thin metal wires arranged on the template.

FIG. 25C illustrates the fabricating method for manufacturing a plurality of plastic microfluidic probes with a single thermoplastic sheet, as shown in FIGS. 25A-B, further depicting molded wires placed on a glass wafer.

FIG. 25D illustrates the fabricating method for manufacturing a plurality of plastic microfluidic probes with a single thermoplastic sheet, as shown in FIGS. 25A-C, further depicting a thermoplastic sheet placed on the wire molds.

FIG. 25E illustrates the fabricating method for manufacturing a plurality of plastic microfluidic probes with a single thermoplastic sheet, as shown in FIGS. 25A-D, further depicting where the plastic microfluidic probe is formed via a hot press.

FIG. 25F illustrates the fabricating method for manufacturing a plurality of plastic microfluidic probes with a single thermoplastic sheet, as shown in FIGS. 25A-E, further depicting the fabricated plastic microfluidic probes.

FIG. 25G illustrates the fabricating method for manufacturing a plurality of plastic microfluidic probes with a single thermoplastic sheet, as shown in FIGS. 25A-F, further depicting a plastic microfluidic probe being assembled and aligned at a mass spectrometer inlet.

FIG. 25H illustrates an analysis of bio-tissue with images taken from the plastic microfluidic probe.

FIG. 25I illustrates an analysis of representative positive mode ion images of endogenous lipids and metabolites in bio-tissue.

FIG. 26 illustrates imaging results of kidney tissue using the plastic microfluidic probe, further depicting the high spatial resolution which enables the accurate localization of lipids and metabolites to different anatomical regions of the tissue.

FIG. 27 illustrates representative positive mode ion images of endogenous lipids and metabolites in kidney tissues showing several distinct distributions across the tissue.

FIG. 28 illustrates an expanded front elevational view of a silicon mold for fabricating a plastic microfluidic probe, according to one embodiment of the present disclosure.

FIG. 29 illustrates a single-pixel mass spectra obtained at scan rate of 40 μm/s showing a high sensitivity.

FIG. 30 illustrates representative positive mode ion images of phospholipids acquired in human kidney tissue section using the plastic microfluidic probe fabricated from the silicon mold, wherein PC, SM, and PE represent phosphatidylcholine, sphingomyelin, and phosphatidylethanolamine, respectively.

FIG. 31 illustrates representative ion images of endogenous molecules acquired in mouse uterine tissue, wherein the ion images are normalized to the total ion count (TIC).

FIG. 32A illustrates the ion image of SM 34:1 in mouse uterine tissue section, as shown in FIG. 31, further depicting a white line which indicates a location of the line profile shown in FIG. 32B.

FIG. 32B illustrates a representative line profile of SM 34:1 along the white line in FIG. 32A, further depicting where the ion signal is normalized to the TIC.

FIG. 32C illustrates an expanded view of the core and boundary region in LE, as shown in FIGS. 32A-32B.

FIG. 32D illustrates a partial line profile extracted along the white line, as shown in FIG. 32C, further depicting the spatial resolution to be ˜12 μm, and arrows indicating maximum (100%) and minimum (0%) values, the dashed lines indicate the positions at which the SM 34:1 signal is at 20% and 80% of its minimum and maximum value, respectively.

FIG. 33 illustrates a first method of fabricating the plastic microfluidic probe, according to one embodiment of the present disclosure.

FIG. 34 illustrates a second method of fabricating the plastic microfluidic probe, further depicting a process to fabricate a plurality of plastic microfluidic probes with a single thermoplastic sheet, according to one embodiment of the present disclosure.

### DETAILED DESCRIPTION

The following description of technology is merely exemplary in nature of the subject matter, manufacture, and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature unless otherwise disclosed, and thus, the order of the steps can be different in various embodiments, including where certain steps can be simultaneously performed.

### I. Definitions

Unless otherwise defined, all technical terms used herein have the same meaning as commonly understood by one of ordinary skill in the art to which the present disclosure pertains.

As used herein, the terms “a” and “an” indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters. In the present disclosure the terms “about” and “around” may allow for a degree of variability in a value or range, for example, within 10%, within 5%, or within 1% of a stated value or of a stated limit of a range. Likewise, in the present disclosure the term “substantially” can allow for a degree of variability in a value or range, for example, within 90%, within 95%, or within 99% of a stated value or of a stated limit of a range.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping, or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below,” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

### II. Description

The present disclosure provides systems and methods that allow for nanospray desorption electrospray ionization (nano-DESI) analysis, including mass spectrometry imaging (MSI) with high spatial resolution and with substantially higher robustness and throughput than current nano-DESI techniques. Probes are provided that incorporate primary and spray channels in a single probe at a fixed orientation to maintain the precise angles between the channels and height of the solvent volume, which produces a liquid bridge at the channel intersection for sample analysis. The probe can further incorporate shear force or other sensors to measure and maintain the optimum distance between the probe tip and the sample surface for liquid bridge formation and successful analyte desorption.

Nano-DESI uses localized liquid extraction into a flowing liquid bridge between the surface of a sample and the nano-DESI probe followed by controlled transfer of the analytes into a proximate mass spectrometer. The sample and nano-DESI probe may be moved relative to each other and the analytes obtained at each point can be mapped to provide an image depicting spatial distribution of the analyte within the sample. Nano-DESI can be performed at ambient pressure as opposed to the vacuum requirements of conventional mass spectrometry analysis which allows for coupling with any type of a mass spectrometer and ensures ease of operation since the sample no longer has to be placed in vacuum.

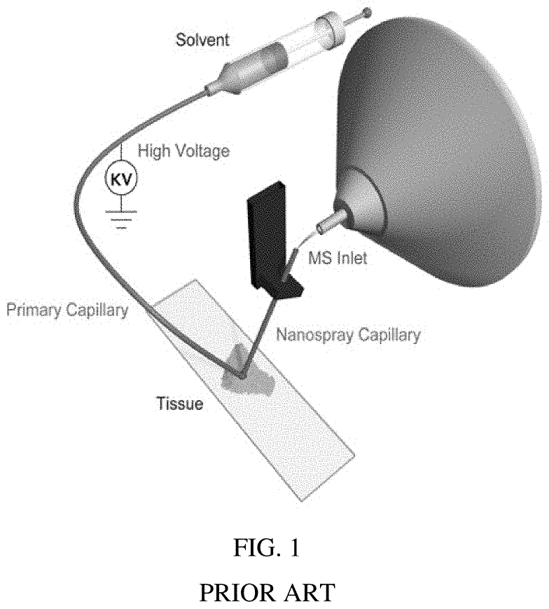

Nano-DESI, as depicted in FIG. 1, uses a liquid bridge of solvent at the surface of the sample where the flowing solvent from one channel desorbs analytes at the liquid bridge and carries them into the other channel to be delivered for analysis (e.g., electrosprayed into a mass spectrometer inlet). The formation of the liquid bridge relies heavily on precise orientation of the two channels and the sample surface to be analyzed. Existing nano-DESI techniques have required a user to set up this orientation by precisely positioning the primary capillary and the nanospray capillary relative to each other, relative to a mass spectrometer inlet, and relative to the tissue to be analyzed. That set-up provides an opportunity for the introduction of user error, especially when operating with finely-pulled glass capillaries used in high-resolution imaging experiments. Furthermore, the required setup is time-intensive, slowing down the throughput and negatively impacting the practicality of otherwise promising nano-DESI MSI analysis.

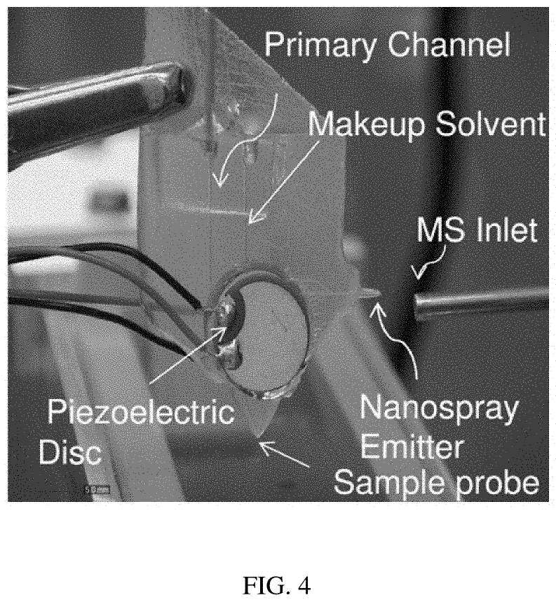

An exemplary probe of the present disclosure is depicted in FIG. 4. The primary and spray channels are etched into the glass and sealed therein meeting at an opening in the sample probe tip at a fixed angle. The exemplary probe includes a makeup solvent channel for introducing additional solvent after the liquid bridge and before the solvent with sample analyte is sprayed out of the nanospray emitter from the spray channel into the inlet of a mass spectrometer. The probe includes a piezoelectric disc for shear-force detection as discussed below.

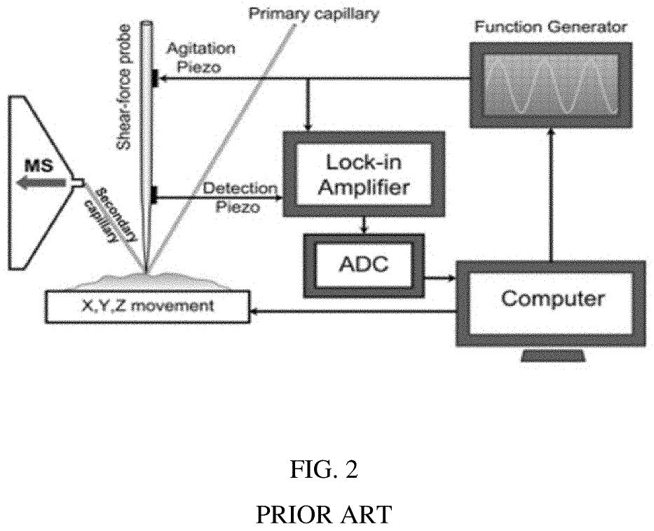

In order to maintain the desired distance between the primary and secondary capillaries and the sample surface, shear-force microscopy techniques have been employed as shown in FIG. 2. Shear force microscopy compensates for sample topography by measuring a shear force between an oscillating probe (e.g., a nanopipette) and a sample surface. The distance between the sample and the shear force probe is adjusted based on feedback from the sensor to maintain the oscillation amplitude of a resonant mode most sensitive to the sample surface at a constant value. As shown in FIG. 2, a shear force nanopipette has been positioned close (within 10-20 microns) to the primary and spray/secondary capillaries of a nano-DESI configuration to measure and maintain a desired distance between the capillaries and the sample surface. Such experiments are described in Nguyen, et al., 2017, Constant-Distance Mode Nanospray Desorption Electrospray Ionization Mass Spectrometry Imaging of Biological Samples with Complex Topography, Anal Chem. 89(2):1131-1137 and Nguyen, et al., 2018, Towards High-Resolution Tissue Imaging Using Nanospray Desorption Electrospray Ionization Mass Spectrometry Coupled to Shear Force Microscopy, J Am Soc Mass Spectrom. 2018 February; 29(2): 316-322, the content of each of which is incorporated herein by reference. When using a separate shear-force probe, the probe has the opportunity to interfere with the liquid bridge due to its positioning at the capillary/sample interface. The primary capillary of the nano-DESI probe itself has also been used as a shear-force probe but due to the positioning, that configuration leads to clogging of the capillaries and other issues.

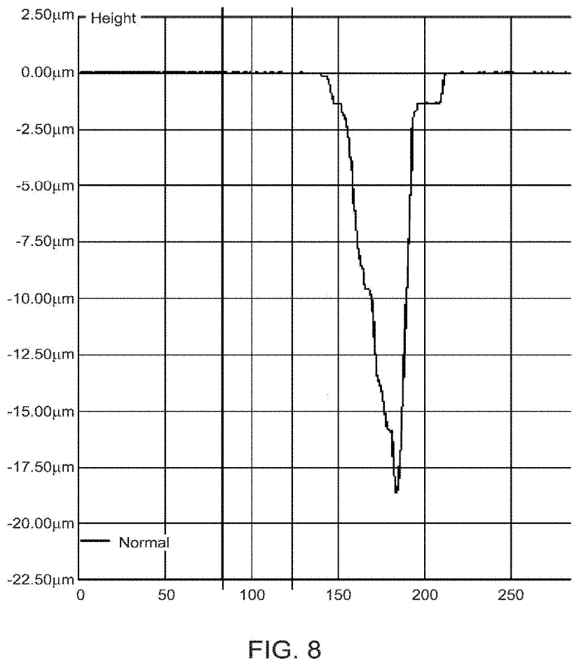

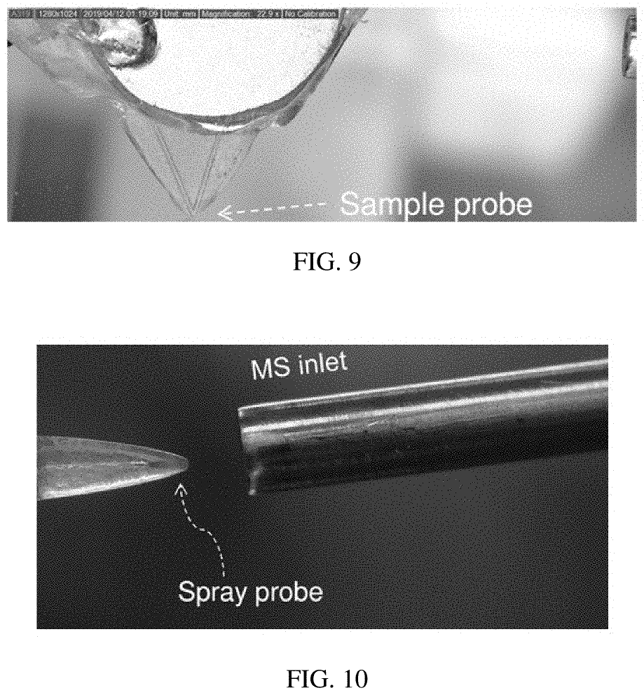

Systems and methods of the present disclosure incorporate shear force sensors into the probe body itself such that the probe not only fixes the orientation of the primary and spray channels to one another in the desired configuration for liquid bridge formation but can also maintain the optimum distance between the opening of those channels and the sample surface. As shown in FIG. 4, one or more piezoelectric discs incorporated into the probe itself can oscillate the entire tip while translating across the sample surface and the tip's position can be adjusted to maintain the optimum orientation for liquid bridge formation. Shear force feedback can be used to maintain the distance between the sample and the device to within 0.1-10 microns and preferably within 1 micron. The size of the device is preferably optimized for the best performance of the shear force feedback mechanism where a lighter-weight probe can provide improved shear force feedback with more controlled oscillation. FIG. 9 shows an enlarged view of the sample probe tip constructed of glass with the formed primary and spray channels visible therein along with the position of a piezoelectric disc near the tip. An enlarged view of the nanospray emitter positioned near an MS inlet is shown in FIG. 10. The nanospray emitter and sample probe tip along with connecting channels are all monolithically fabricated in glass to preserve their orientation.

Two piezoelectric discs can be used for shear force measurement of probe displacement. Using the same position on both sides of the device allows for high signal transmission and improves the sensitivity of the shear force feedback comparable to the performance of a separate shear force probe. Additionally piezoelectric disc positioning can reduce the effect of probe weight on the sensitivity of the shear force probe when positioned near to the sample probe tip.

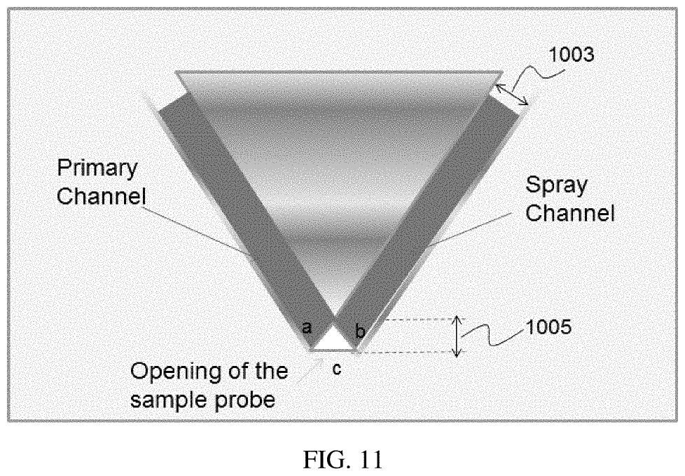

In order to minimize the effect of the shape of the sample probe on shear force a sample probe tip cross-section of about 40 μm or below is preferred but larger tips may be used at the expense of spatial resolution. The size of the liquid bridge is important for providing consistent, accurate, and specific results using nano-DESI. The ability to control the size of the liquid bridge formed by the sample probe to the sample surface is a major contribution of the systems and methods described herein and provides a mass spectrum with a high signal to noise ratio and signal stability. The two channels comprising the sample probe produce a liquid bridge between the solvent flowing inside the device and sample surface. The size of the liquid bridge is controlled by the size of the channels forming the liquid bridge and the flow rate of the solvent through the device. In preferred embodiments for producing maximum signal, the height of the triangle abc shown in FIG. 11 is near to or approximately equal to the width of the channels. For example, in FIG. 11, the width 1003 of the solvent channel and the width of the spray channel are 30 μm and the height 1005 of the triangle abc is 30 μm. This design provided the best mass spectra in terms of the SIN ratio.

Probes may be produced using standard photolithography technology, including chrome plating, sputtering photoresist, mask fabrication, exposure, and wet etching. Wet etching conditions can be optimized to obtain smooth channel surfaces. The etching rate can be reduced by diluting the etch solution. Dilution with NH4F is preferred to dilution with water because it increases and stabilizes the pH value of the solution, ensuring a relatively slow and constant etch rate. Uniform channel dimensions and smooth wall surfaces can be obtained using an optimized etching solution with the following concentration ratios: BOE (buffer oxide etch solution):H2O:NH4F:HCl=1:7:2.5:0.2, for which the etch rate is ˜0.8 μm/min.

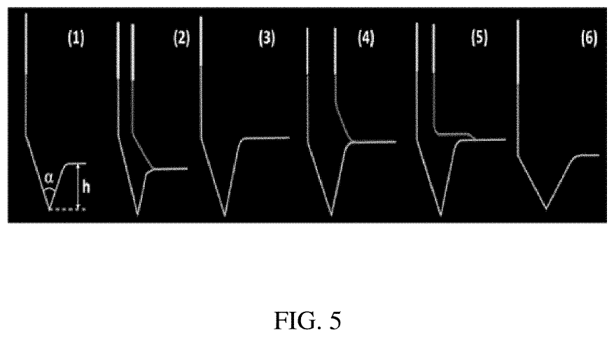

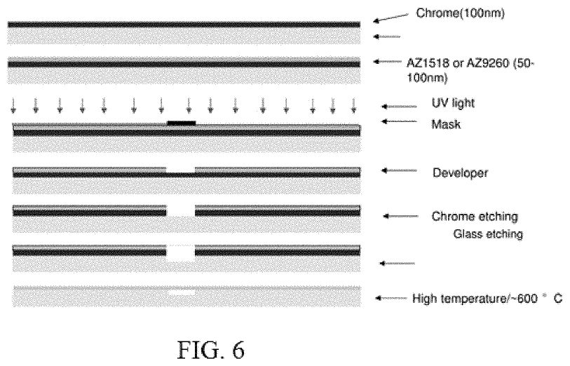

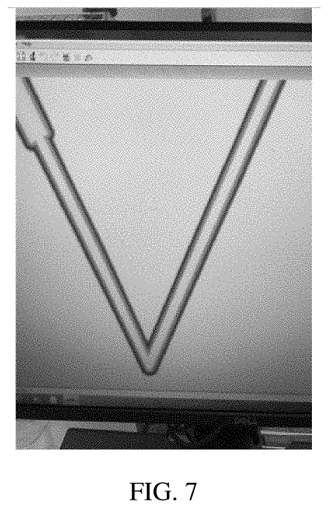

Exemplary probe formation is diagramed in FIG. 6 showing chrome plating, application of photoresist (e.g., AZ1518), and a photomask such as those shown in FIG. 5 and discussed below. UV light is applied to the masked substrate followed by developer, chrome and glass etching, and high temperature bonding of a sealing layer on top of the etched channels in the glass substrate. An image of etched channels in glass is shown in FIG. 7 and a depth measurement of an etched channel is shown in FIG. 8.

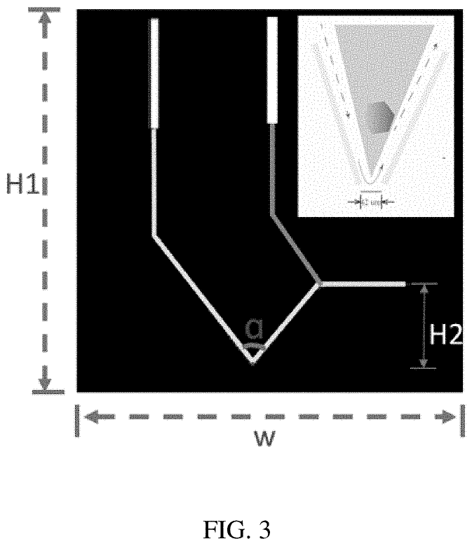

FIG. 3 shows a general probe design and various photomask designs for etching channels for probes of the present disclosure are shown in FIG. 5. FIG. 5 shows enhanced drawings of six photomasks used to fabricate microfluidic nano-DESI probes where a designates the angle between the primary/solvent channel and the spray channel. The distance between the opening of the probe (where the liquid bridge is formed) and the nanospray emitter or spray nozzle for ionization at the MS inlet is designated by h in FIGS. 5 and H2 in FIG. 3. Photomasks 2, 4, and 5 include a makeup solvent channel for introducing solvent after the liquid bridge and before electrospray. Makeup solvent channel helps propel the solvent through the probe and thereby eliminates the need for using the instrument vacuum to assist solvent flow making the use of this probe platform-independent. Furthermore, makeup solvent channel enables elaborate solvent mixing strategies for improving the extraction and ionization efficiency, online derivatization or selective modification of extracted analytes using chemical reagents or light, desalting of the analytes prior to analysis. The openings of the channels may be of a wider cross-sectional width or depth to accommodate connections to solvent or other fluid sources or for coupling of spray nozzles as shown in FIGS. 3 and 5. In FIG. 3 H1 designates the overall height of the probe and the overall width. The inset of FIG. 3 shows an exemplary probe tip with the arrows designating the flow of solvent down the primary channel, through the liquid bridge at the sample surface, and into the spray channel to be directed to the nanospray emitter. In the inset image, an opening at the tip of about 42 μm is shown corresponding to a preferred configuration of 30 μm channel cross-sectional width arranged to form a triangle as shown in FIG. 11.

The device can be fabricated by bonding the glass slide containing etched microfluidic channels with a plain glass slide, which seals the channels. Post-processing of the device requires very strong bonding of the two components. High-temperature bonding is preferred to prevent breakage during post-processing. Other bonding methods such as UV adhesive or anodic bonding can be used but, due to their lower strength, high-temperature bonding is preferred. In order to increase success rates in high-temperature bonding a two-step heating process can be used in a standard muffle oven. The following steps can be used in the preferred heating process. A 5-hour long temperature ramp to 585° C.-595° C. followed by a constant-temperature bonding step for 3 hours. Subsequent cooling of the device also is important. A slow cooling rate is preferred to prevent fractures in the glass slides. The glass slides are preferably held in a horizontal orientation during bonding to avoid deformation and to maintain channel geometry.

Various types of glass may be used to fabricate the device including soda lime and borosilicate glass. Post-processing can include glass polishing and grinding to produce the nanospray emitter and the sample probe as shown in FIG. 4. The nanospray emitter is preferably small and sharp to ensure stable electrospray signal. The thickness of the sample probe tip can be reduced to ˜0.1 mm. Both smaller and larger sample probe tip thickness may be used depending on the desired spatial resolution in nano-DESI MSI.

Fluidic ports can be fabricated in the probe using deep etching and partial deep etching technology. Accordingly, commercially available glass capillary with an O.D. (outer diameter) of 360 μm can be seamlessly connected to the 30 μm microfluidic channel of the device with little dead volume and high pressure and temperature tolerance for coupling to a solvent source and introduction of solvent into the primary channel.

Height of the probe can be between about 0.2 to about 50 mm. Width of the probe can be between about 0.2 mm to about 50 mm. Depth of the probe can be between about 0.2 mm and about 5 mm. In preferred embodiments the probe may be about 1.0 cm tall by 1.0 cm wide and 0.1 cm deep.

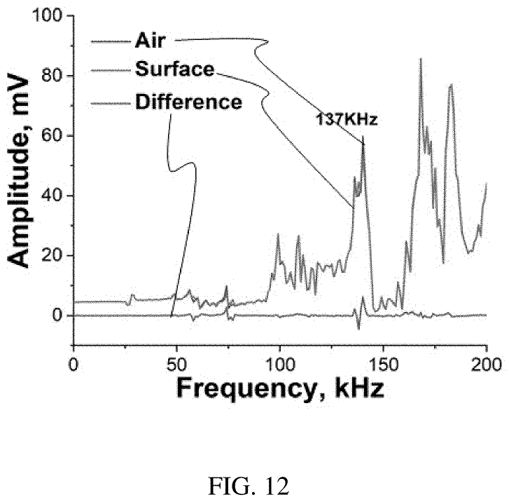

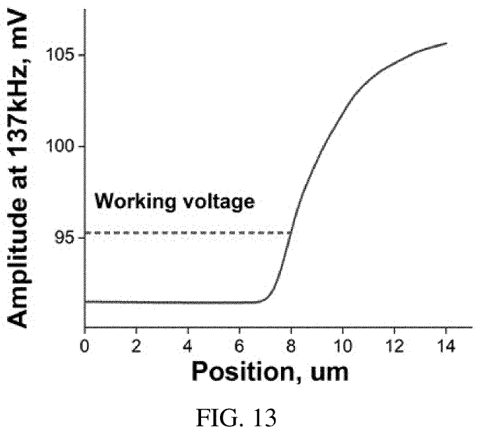

Exemplary excitation spectra corresponding to the natural vibrations of the probe operated in the shear force mode are shown in FIG. 12 as acquired with a probe of the present disclosure. Traces are shown with the probe kept in the air and positioned on the glass surface as well as one representing the difference spectrum between air and glass surface. 137.0 kHz was determined to be a preferred frequency for this probe showing the most advantageous difference in amplitude between the air and glass surfaces. FIG. 13 shows an approach curve acquired at the optimized frequency of 137.0 kHz showing the amplitude of the shear force probe vibration as a function of the distance between the probe and sample surface. The frequency may be different for different probes. Accordingly, the amplitude of the shear force probe oscillation at 137.0 kHz is maintained at the same value during nano-DESI MSI using systems and methods of the present disclosure. Alternatively, frequencies of about 60 kHz, about 75 kHz, about 100 kHz, about 115 kHz or about 170 kHz can be used, among others. The optimal oscillation frequency is determined for each device and depends on its design and weight.

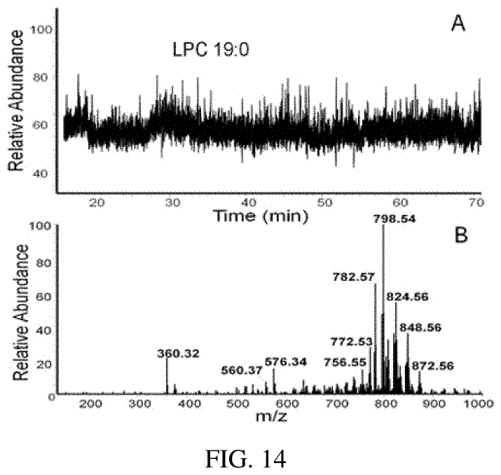

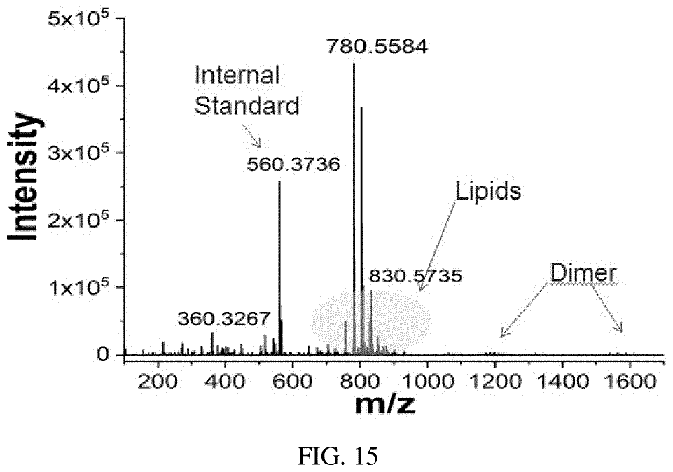

FIG. 14 panels A-B show performance evaluation of the iMFP, (Panel A) Ion chronogram of the internal standard (LPC 19:0) signal from continuous monitoring for around one hour, the signal is normalized to the total ion current (TIC). In this experiment, the iMFP is brought in contact with the surface of a glass slide and the signal of the standard at m/z 560.37 is measured as a function of time; (Panel B) A single-pixel positive mode nano-DESI spectrum of a mouse uterine tissue showing SIN of ˜90 for the most abundant lipid peak. FIG. 15 shows a single scan positive mode nano-DESI spectrum of a mouse pancreatic tissue representing the signal in one pixel of an image obtained using systems and methods described herein.

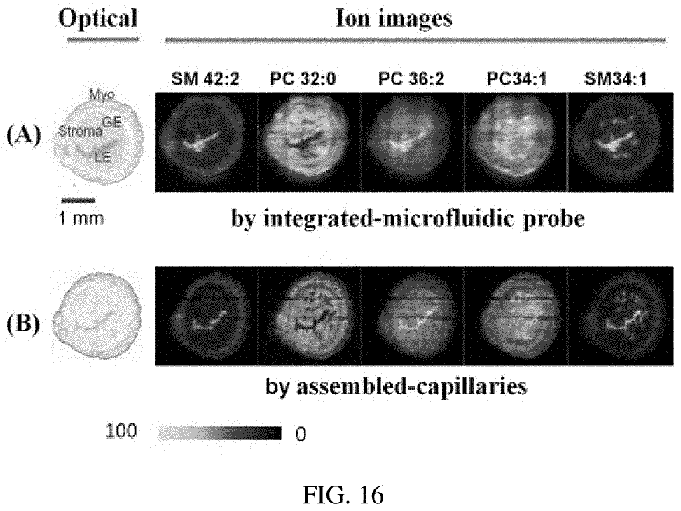

FIG. 16 panels A-B Representative positive ion images of [M+Na]+ ions of molecules in mouse uterine tissues obtained using iMFP (Panel A) and capillary-based nano-DESI probe (Panel B). Scale bar: 1 mm; the intensity scale: black (low), yellow (high).

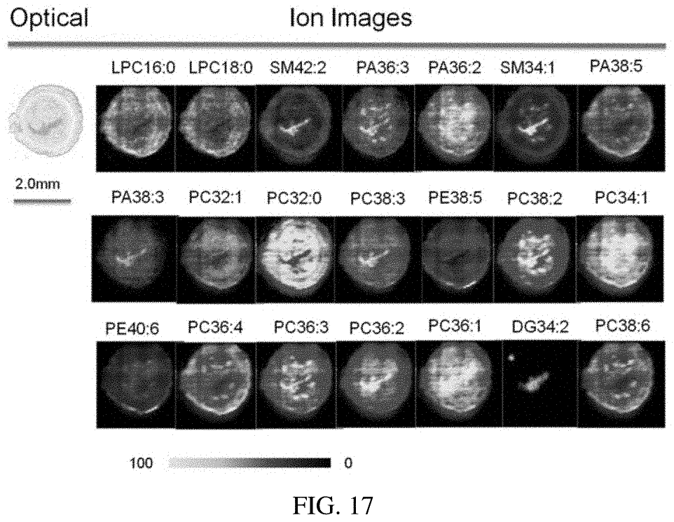

FIG. 17 representative positive ion images of [M+Na]+ ions of phospholipids obtained in mouse uterine tissue sections using the iMFP. The experimental conditions are as follows: scan rate of 20 μmis, solvent flow rate of 1.0 μL/min, spray voltage of 3000 V, and a distance from the emitter tip to the mass spectrometer inlet of ˜0.5 mm.

General nano-DESI MSI methods, as characterized for example in Lanekoff, Analyst, 138, 1971-1978 (2013) and Lanekoff, Anal. Chem., 86, 1872-1880 (2014) (incorporated herein by reference) and in Yin, Nat. Protocols 14, 3445-3470 (2019) can be used with nano-DESI systems and methods of the present disclosure including solvent choices, ion analysis devices, imaging and analysis software, and stage and probe translation devices.

As one skilled in the art would recognize as necessary or best-suited for the systems and methods of the present disclosure, systems and methods of the present disclosure may include computing devices for controlling the nano-DESI MSI processes including MS analysis, sample and probe manipulation, image assembly, processing, and visualization, as well as other procedures advantageously controlled by a computer. Where used, computers may include one or more of processor (e.g., a central processing unit (CPU), a graphics processing unit (GPU), etc.), computer-readable storage device (e.g., main memory, static memory, etc.), or combinations thereof which communicate with each other via a bus. Computing devices may include mobile devices (e.g., cell phones), personal computers, and server computers. In various embodiments, computing devices may be configured to communicate with one another via a network.

A processor may include any suitable processor known in the art, such as the processor sold under the trademark XEON E7 by Intel (Santa Clara, Calif.) or the processor sold under the trademark OPTERON 6200 by AMD (Sunnyvale, Calif.).

Memory preferably includes at least one tangible, non-transitory medium capable of storing: one or more sets of instructions executable to cause the system to perform functions described herein (e.g., software embodying any methodology or function found herein); data (e.g., data to be encoded in a memory strand); or both. While the computer-readable storage device can in an exemplary embodiment be a single medium, the term “computer-readable storage device” should be taken to include a single medium or multiple media (e.g., a centralized or distributed database, and/or associated caches and servers) that store the instructions or data. The term “computer-readable storage device” shall accordingly be taken to include, without limit, solid-state memories (e.g., subscriber identity module (SIM) card, secure digital card (SD card), micro SD card, or solid-state drive (SSD)), optical and magnetic media, hard drives, disk drives, and any other tangible storage media.

Any suitable services can be used for storage such as, for example, Amazon Web Services, cloud storage, another server, or other computer-readable storage. Cloud storage may refer to a data storage scheme wherein data is stored in logical pools and the physical storage may span across multiple servers and multiple locations. Storage may be owned and managed by a hosting company. Preferably, storage is used to store records as needed to perform and support operations described herein.

Input/output devices according to the present disclosure may include one or more of a video display unit (e.g., a liquid crystal display (LCD) or a cathode ray tube (CRT) monitor), an alphanumeric input device (e.g., a keyboard), a cursor control device (e.g., a mouse or trackpad), a disk drive unit, a signal generation device (e.g., a speaker), a touchscreen, a button, an accelerometer, a microphone, motors for stage or probe translation, ion analysis devices, a cellular radio frequency antenna, a network interface device, which can be, for example, a network interface card (NIC), Wi-Fi card, or cellular modem, or any combination thereof.

One of skill in the art will recognize that any suitable development environment or programming language may be employed to allow the operability described herein for various systems and methods of the present disclosure. For example, systems and methods herein can be implemented using Perl, Python, C++, C #, Java, JavaScript, Visual Basic, Ruby on Rails, Groovy and Grails, or any other suitable tool. For a computing device, it may be preferred to use native xCode or Android Java.

### DESI, DESI-Imaging, and Non-Destructive Solvents

As a background, DESI and certain aspects of DESI and it's use with non-destructive solvents is described in U.S. Pat. Nos. 9,546,979 and 9,157,921, the content of each of which is incorporated by reference herein in its entirety. This may be useful if the systems and methods of the present disclosure are used to analyze tissue samples.

DESI is an ambient ionization method that allows the direct ionization of species from a sample (Takats et al., Science, 306:471-473, 2004 and Takats, U.S. Pat. No. 7,335,897). DESI-MS imaging is described for example in Eberlin et al. (Biochimica Et Biophysica Acta-Molecular And Cell Biology Of Lipids accepted) and Cooks R G, et al. (2011), Faraday Discussions 149:247-267), the content of each of which is incorporated by reference herein in its entirety.

Use of DESI for imaging is described in Wiseman et al. Nat. Protoc., 3:517, 2008, the content of which is incorporated by reference herein its entirety. In general, for DESI imaging, each pixel yields a mass spectrum, which can then be compiled to create an image showing the spatial distribution of a particular compound or compounds. Such an image allows one to visualize the differences in the distribution of particular compounds in a sample, such as a tissue section. If independent information on biological properties of the sample is available, then the MS spatial distribution can provide chemical correlations with biological function or morphology.

If tissue sections are being analyzing, one may want to use a liquid phase that does not destroy native tissue morphology. Any liquid phase that does not destroy native tissue morphology and is compatible with mass spectrometry may be used with systems and methods of the present disclosure. Exemplary liquid phases include DMF, ACN, and THF. In certain embodiments, the liquid phase is DMF. In certain embodiments, the DMF is used in combination with another component, such as EtOH, H2O, ACN, and a combination thereof. Other exemplary liquid phases that do not destroy native tissue morphology include ACN:EtOH, MeOH:CHCh, and ACN:CHCh. This is further described for example in U.S. Pat. No. 9,157,921, the content of which is incorporated by reference herein in its entirety.

### Liquid Bridges

A liquid bridge, for example, is a mass of liquid sustained by the action of the surface tension force between two or more supporting structure. Liquid bridges are described for example in WO 2007/091228; U.S. Pat. Nos. 10,626,451; 10,513,729; 10,499,995; 9,789,484; 9,631,230; 9,597,644; 9,533,304; 9,387,472; 9,322,511; 9,108,177; 8,968,659; 8,741,660; 8,735,169; 8,697,011; 8,563,244; 8,550,503; 8,501,497; 8,298,833; 7,993,911; and 7,622,076, the content of each of which is incorporated by reference herein in its entirety. In certain embodiments, a liquid bridge relates to a liquid droplet containing a sample. The droplet acts as an intermediate (a bridge) between two or more solid structures, such as two capillaries. In an example, a typical liquid bridge is formed by a droplet on a surface positioned between a first and second capillary, in which the capillaries do not contact each other and are in fluid communication only via the liquid droplet.

### Mass Spectrometers

Any mass spectrometer known in the art can be used in systems of the present disclosure. Exemplary ion traps include a hyperbolic ion trap (e.g., U.S. Pat. No. 5,644,131, the content of which is incorporated by reference herein in its entirety), a cylindrical ion trap (e.g., Bonner et al., International Journal of Mass Spectrometry and Ion Physics, 24(3):255-269, 1977, the content of which is incorporated by reference herein in its entirety), a linear ion trap (Hagar, Rapid Communications in Mass Spectrometry, 16(6):512-526, 2002, the content of which is incorporated by reference herein in its entirety), and a rectilinear ion trap (U.S. Pat. No. 6,838,666, the content of which is incorporated by reference herein in its entirety). Any mass spectrometer (e.g., bench-top mass spectrometer of miniature mass spectrometer) may be used in systems of the present disclosure and in certain embodiments the mass spectrometer is a miniature mass spectrometer. An exemplary miniature mass spectrometer is described, for example in Gao et al. (Anal. Chem. 2008, 80, 7198-7205.), the content of which is incorporated by reference herein in its entirety. In comparison with the pumping system used for lab-scale instruments with thousands of watts of power, miniature mass spectrometers generally have smaller pumping systems, such as a 18 W pumping system with only a 5 L/min (0.3 m3/hr) diaphragm pump and a 11 Lis turbo pump for the system described in Gao et al. Other exemplary miniature mass spectrometers are described for example in Gao et al. (Anal. Chem., 2008, 80, 7198-7205.), Hou et al. (Anal. Chem., 2011, 83, 1857-1861.), and Sokol et al. (Int. J. Mass Spectrom., 2011, 306, 187-195), the content of each of which is incorporated herein by reference in its entirety.

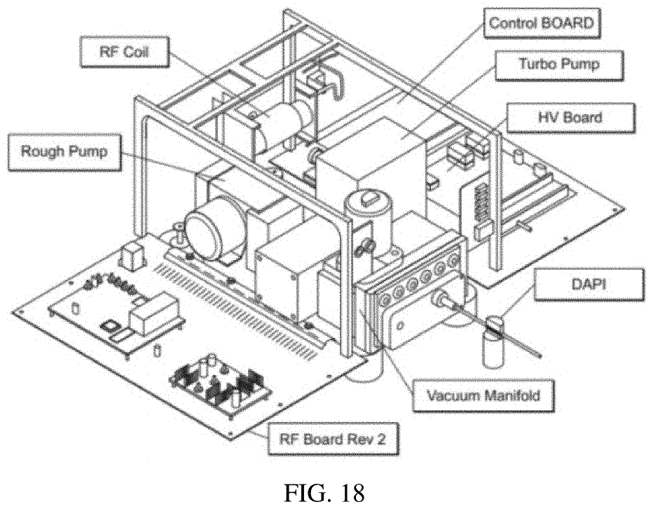

FIG. 18 is a picture illustrating various components and their arrangement in a miniature mass spectrometer. The control system of the Mini 12 (Linfan Li, Tsung-Chi Chen, Yue Ren, Paul I. Hendricks, R. Graham Cooks and Zheng Ouyang “Miniature Ambient Mass Analysis System” Anal. Chem. 2014, 86 2909-2916, DOI: 10.1021/ac403766c; and 860. Paul I. Hendricks, Jon K. Dalgleish, Jacob T. Shelley, Matthew A. Kirleis, Matthew T. McNicholas, Linfan Li, Tsung-Chi Chen, Chien-Hsun Chen, Jason S. Duncan, Frank Boudreau, Robert J. Noll, John P. Denton, Timothy A. Roach, Zheng Ouyang, and R. Graham Cooks “Autonomous in-situ analysis and real-time chemical detection using a backpack miniature mass spectrometer: concept, instrumentation development, and performance” Anal. Chem., 2014, 86 2900-2908 DOI: 10.1021/ac403765x, the content of each of which is incorporated by reference herein in its entirety), and the vacuum system of the Mini 10 (Liang Gao, Qingyu Song, Garth E. Patterson, R. Graham Cooks and Zheng Ouyang, “Handheld Rectilinear Ion Trap Mass Spectrometer”, Anal. Chem., 78 (2006) 5994-6002 DOI: 10.1021/ac061144k, the content of which is incorporated by reference herein in its entirety) may be combined to produce the miniature mass spectrometer shown in FIG. 18. It may have a size similar to that of a shoebox (H20×W25 cm×035 cm). In certain embodiments, the miniature mass spectrometer uses a dual LIT configuration, which is described for example in Owen et al. (U.S. patent application Ser. No. 14/345,672), and Ouyang et al. (U.S. patent application Ser. No. 61/865,377), the content of each of which is incorporated by reference herein in its entirety.

### System Architecture

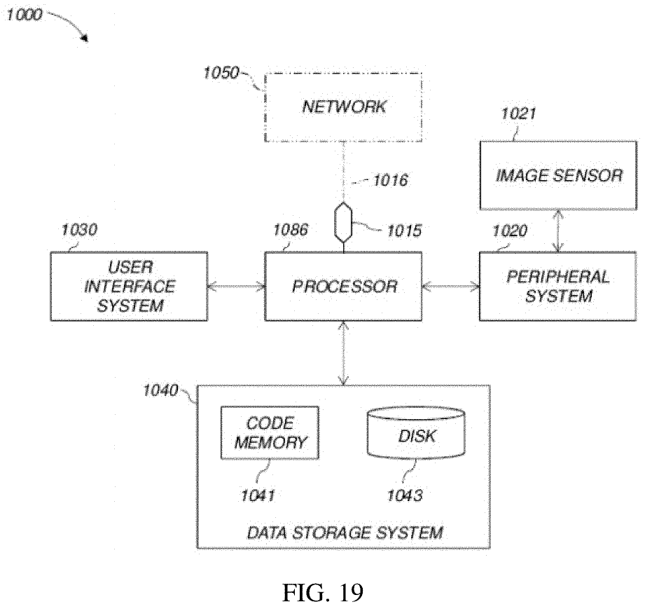

FIG. 19 is a high-level diagram showing the components of an exemplary data-processing system 1000 for analyzing data and performing other analyses described herein, and related components. The system includes a processor 1086, a peripheral system 1020, a user interface system 1030, and a data storage system 1040. The peripheral system 1020, the user interface system 1030 and the data storage system 1040 are communicatively connected to the processor 1086. Processor 1086 can be communicatively connected to network 1050 (shown in phantom), e.g., the Internet or a leased line, as discussed below. The data described above may be obtained using detector 1021 and/or displayed using display units (included in user interface system 1030) which can each include one or more of systems 1086, 1020, 1030, 1040, and can each connect to one or more network(s) 1050. Processor 1086, and other processing devices described herein, can each include one or more microprocessors, microcontrollers, field-programmable gate arrays (FPGAs), application-specific integrated circuits (ASICs), programmable logic devices (PLDs), programmable logic arrays (PLAs), programmable array logic devices (PALs), or digital signal processors (DSPs).

Processor 1086 which in one embodiment may be capable of real-time calculations (and in an alternative embodiment configured to perform calculations on a non-real-time basis and store the results of calculations for use later) can implement processes of various aspects described herein. Processor 1086 can be or include one or more device(s) for automatically operating on data, e.g., a central processing unit (CPU), microcontroller (MCU), desktop computer, laptop computer, mainframe computer, personal digital assistant, digital camera, cellular phone, smartphone, or any other device for processing data, managing data, or handling data, whether implemented with electrical, magnetic, optical, biological components, or otherwise. The phrase “communicatively connected” includes any type of connection, wired or wireless, for communicating data between devices or processors. These devices or processors can be located in physical proximity or not. For example, subsystems such as peripheral system 1020, user interface system 1030, and data storage system 1040 are shown separately from the data processing system 1086 but can be stored completely or partially within the data processing system 1086.

The peripheral system 1020 can include one or more devices configured to provide digital content records to the processor 1086. For example, the peripheral system 1020 can include digital still cameras, digital video cameras, cellular phones, or other data processors. The processor 1086, upon receipt of digital content records from a device in the peripheral system 1020, can store such digital content records in the data storage system 1040.

The user interface system 1030 can include a mouse, a keyboard, another computer (e.g., a tablet) connected, e.g., via a network or a null-modem cable, or any device or combination of devices from which data is input to the processor 1086. The user interface system 1030 also can include a display device, a processor-accessible memory, or any device or combination of devices to which data is output by the processor 1086. The user interface system 1030 and the data storage system 1040 can share a processor-accessible memory.

In various aspects, processor 1086 includes or is connected to communication interface 1015 that is coupled via network link 1016 (shown in phantom) to network 1050. For example, communication interface 1015 can include an integrated services digital network (ISDN) terminal adapter or a modem to communicate data via a telephone line; a network interface to communicate data via a local-area network (LAN), e.g., an Ethernet LAN, or wide-area network (WAN); or a radio to communicate data via a wireless link, e.g., WiFi or GSM. Communication interface 1015 sends and receives electrical, electromagnetic or optical signals that carry digital or analog data streams representing various types of information across network link 1016 to network 1050. Network link 1016 can be connected to network 1050 via a switch, gateway, hub, router, or other networking device.

Processor 1086 can send messages and receive data, including program code, through network 1050, network link 1016 and communication interface 1015. For example, a server can store requested code for an application program (e.g., a JAVA applet) on a tangible non-volatile computer-readable storage medium to which it is connected. The server can retrieve the code from the medium and transmit it through network 1050 to communication interface 1015. The received code can be executed by processor 1086 as it is received, or stored in data storage system 1040 for later execution.

Data storage system 1040 can include or be communicatively connected with one or more processor-accessible memories configured to store information. The memories can be, e.g., within a chassis or as parts of a distributed system. The phrase “processor-accessible memory” is intended to include any data storage device to or from which processor 1086 can transfer data (using appropriate components of peripheral system 1020), whether volatile or nonvolatile; removable or fixed; electronic, magnetic, optical, chemical, mechanical, or otherwise. Exemplary processor-accessible memories include but are not limited to: registers, floppy disks, hard disks, tapes, bar codes, Compact Discs, DVDs, read-only memories (ROM), Universal Serial Bus (USB) interface memory device, erasable programmable read-only memories (EPROM, EEPROM, or Flash), remotely accessible hard drives, and random-access memories (RAMs). One of the processor-accessible memories in the data storage system 1040 can be a tangible non-transitory computer-readable storage medium, i.e., a non-transitory device or article of manufacture that participates in storing instructions that can be provided to processor 1086 for execution.

In an example, data storage system 1040 includes code memory 1041, e.g., a RAM, and disk 1043, e.g., a tangible computer-readable rotational storage device such as a hard drive. Computer program instructions are read into code memory 1041 from disk 1043. Processor 1086 then executes one or more sequences of the computer program instructions loaded into code memory 1041, as a result performing process steps described herein. In this way, processor 1086 carries out a computer implemented process. For example, steps of methods described herein, blocks of the flowchart illustrations or block diagrams herein, and combinations of those, can be implemented by computer program instructions. Code memory 1041 can also store data, or can store only code.

Various aspects described herein may be embodied as systems or methods. Accordingly, various aspects herein may take the form of an entirely hardware aspect, an entirely software aspect (including firmware, resident software, micro-code, etc.), or an aspect combining software and hardware aspects. These aspects can all generally be referred to herein as a “service,” “circuit,” “circuitry,” “module,” or “system.”

Furthermore, various aspects herein may be embodied as computer program products including computer readable program code stored on a tangible non-transitory computer readable medium. Such a medium can be manufactured as is conventional for such articles, e.g., by pressing a CD-ROM. The program code includes computer program instructions that can be loaded into processor 1086 (and possibly also other processors) to cause functions, acts, or operational steps of various aspects herein to be performed by the processor 1086 (or other processor). Computer program code for carrying out operations for various aspects described herein may be written in any combination of one or more programming language(s), and can be loaded from disk 1043 into code memory 1041 for execution. The program code may execute, e.g., entirely on processor 1086, partly on processor 1086 and partly on a remote computer connected to network 1050, or entirely on the remote computer.

### Samples

A wide range of heterogeneous samples can be analyzed, such as biological samples (e.g., tissue samples or microbial colonies), environmental samples (including, e.g., industrial samples and agricultural samples), and food/beverage product samples, etc. Samples may be in any form and preferably are solid samples.

The present disclosure may be embodied in other specific forms without departing from the spirit or essential characteristics thereof. The foregoing embodiments are therefore to be considered in all respects illustrative rather than limiting on the present disclosure described herein.

### III. Example

The following experimental setups, components, characteristics, and results are provided as a specific, non-limiting examples.

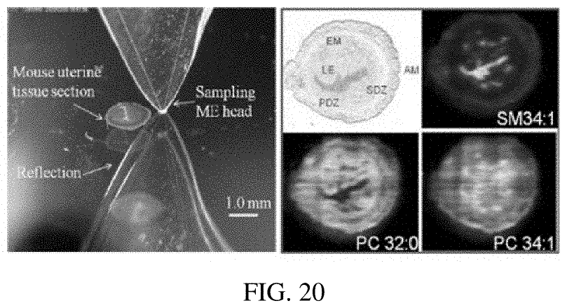

The Examples herein describe an integrated microfluidic probe (iMFP) that is easy to operate and align in front of a mass spectrometer which will facilitate broader use of liquid extraction-based MSI in biological research, drug discovery, and clinical studies (FIG. 20). The incorporation of the iMFP into nano-DESI MSI is a promising strategy for making this imaging technique accessible to the broad scientific community.

Ambient ionization based on liquid extraction is widely used in mass spectrometry imaging (MSI) of molecules in biological samples. The development of nanospray desorption electrospray ionization (nano-DESI) has enabled the robust imaging of tissue sections with high spatial resolution. However, the fabrication of the nano-DESI probe is challenging, which limits its dissemination to the broader scientific community. Herein, is described the design and performance of an integrated microfluidic probe (iMFP) for nano-DESI MSI. The glass iMFP fabricated using photolithography, wet etching, and polishing shows comparable performance to the capillary-based nano-DESI MSI in terms of stability and sensitivity; the spatial resolution of better than 25 μm was obtained in these first proof-of-principle experiments. The iMFP is easy to operate and align in front of a mass spectrometer, which will facilitate broader use of liquid extraction-based MSI in biological research, drug discovery, and clinical studies.

### Example 1: Integrated Microfluidic Probe (iMFP)

Mass spectrometry imaging (MSI) is a powerful analytical tool, which enables both targeted and untargeted label-free detection of molecules in biological samples with high sensitivity and chemical specificity. Although matrix-assisted laser desorption ionization (MALDI) MSI is by far the most widely used technique, substantial effort has been dedicated to the development of ambient MSI approaches. Ambient ionization techniques alleviate the need for sample pre-treatment prior to analysis and enable imaging of biological systems in their native state. Several of these approaches rely on localized liquid extraction. These include desorption electrospray ionization (DESI), liquid micro-junction surface sampling probe (LMJ-SSP), nanospray desorption electrospray ionization (nano-DESI), and single probe, amongst others. Liquid extraction provides the advantages of gentle removal of molecules from specific locations on the surface, flexible selection of the extraction solvent for the efficient extraction of specific classes of analytes, quantification of the extracted analytes by adding standards to the solvent, and efficient compensation for matrix effects. Nano-DESI MSI developed by our group uses two fused silica capillaries in a “V-shaped” configuration referred to as a nano-DESI probe. The probe forms a liquid bridge on the sample surface, into which analyte molecules are extracted and subsequently ionized at a mass spectrometer inlet. High spatial resolution is achieved using finely pulled capillaries and a shear force probe, which controls the distance between the probe and sample surface. This configuration generates high-quality ion images with a spatial resolution of better than 10 μm. Despite the advances in the development of this technique, the fabrication and alignment of the finely pulled capillaries are still challenging. The ability to fabricate an integrated probe for the robust nano-DESI imaging with high spatial resolution will allow the broader scientific community to adapt this technique to a wide range of applications.

Microfluidic technology is a powerful tool for the manipulation of sub-nanoliter liquid volumes, which facilitates the analysis of small samples The ability to process small sample volumes makes the coupling of microfluidic devices with mass spectrometry (MS) particularly advantageous. Others have developed a glass microfluidic chip with a monolithic nanospray emitter, which greatly enhanced the ionization efficiency. Alternatively, ESI has been performed directly from a corner of a rectangular glass microchip used for coupling electrophoretic separations with ESI-MS. The dual-probe microfluidic chip has been used for sampling of analytes from surfaces of dry-spot samples and nanoliter droplets. These studies have demonstrated the power of microfluidics coupled to MS for the analysis of liquid samples. In order to extend these capabilities to MSI, it is important to design a device, which will be able to extract analytes from a well-defined location on a surface and transfer them to a mass spectrometer.

Herein, we introduce an integrated microfluidic probe (iMFP) for nano-DESI MSI and demonstrate its capabilities for imaging of tissue sections. The probe comprises the solvent and spray channels and integrates the sampling port and nanospray emitter in a single chip. The extraction solvent is propelled through the solvent channel by a syringe pump; analyte molecules are extracted into the liquid bridge formed at the sampling port and transferred to a mass spectrometer through the spray channel. Ionization occurs at the finely polished monolithic spray emitter with the high voltage applied to the syringe needle.

The iMFP is fabricated using the procedure described in detail in the experimental section of the supporting information. Briefly, photolithography and wet etching are used to generate channels with a final depth of ˜25 μm and a width of ˜40 μm. A glass wafer containing the microfluidic channels is bonded with a blank glass wafer at 590° C. for 3 hrs.

Subsequent multistep grinding is used to fabricate a finely polished spray emitter and sampling port. The sharp spray emitter determines signal stability. The design of the sampling port is critical to the size and stability of the liquid bridge, which determines the analyte sampling efficiency and the spatial resolution of the probe. The optimized geometry of the sampling port, which provides stable signals and enables sensitive detection of analytes on the sample surface. The distance between the apex to the edge of the port is ˜40 μm; the angle between the solvent and spray channels of 30° provides a stable flow and helps maintain a small size of the liquid bridge on the surface.

The stability of the probe evaluated using a 9:1 (v/v) methanol/water solution containing 320 nM of LPC 19:0 (lysophosphatidylcholine) standard is shown in FIG. 14 panel A. After one hour of continuous signal recording, the relative standard deviation of the signal of the internal standard is ˜4%. The signal-to-noise ratio of ˜90 was obtained for the most abundant lipid peak in the single-pixel mass spectrum of the mouse uterine tissue section (FIG. 14 panel B), which is comparable to the results obtained using a conventional capillary-based nano-DESI probe.

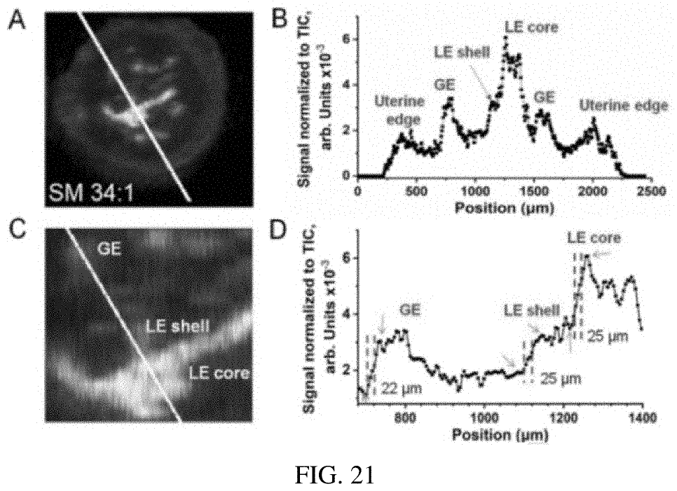

Mouse uterine tissue is an excellent model system, which contains several distinct cell types distributed over a small cross-sectional area of around 2 mm. These include luminal epithelium (LE), the glandular epithelium (GE), and stroma (S) highlighted in FIG. 21 panel A. A detailed description of the experimental parameters is provided in the following g examples. Imaging experiments were performed using the “three-point-plane” approach described in J. Laskin, B. S. Heath, P. J. Roach, L. Cazares, 0. J. Semmes, Anal. Chem. 2012, 84, 141-148, the content of which is incorporated by reference herein in its entirety. The approach compensates for the tilt of the sample plane and is the simplest way to control the distance between the sampling port of the iMFP and the sample surface. At least sixty phospholipids were identified in the sample based on accurate m/z and tandem mass spectrometry data (MS2). Ion images obtained using iMFP MSI are shown in FIG. 16 panel A and FIG. 17. Select images in FIG. 16 panel A correspond to SM42:2, PC32:0, PC36:2, PC34:1, and SM34:1 and highlight the characteristic spatial profiles of phospholipids observed in mouse uterine tissue sections. We observe distinct patterns of phospholipid localization to the heterogeneous cell types (LE, GE, and stroma) of the mouse uterine tissue. Specifically, we observed that SM34:1 is enhanced in both LE and GE whereas SM 42:2 is only enhanced in LE. In contrast to SM species, PC species show distinctly different distributions depending on the length of the fatty acyl chains and degree of unsaturation. For example, PC32:0 is enhanced in GE and stroma, PC 34:1 is evenly distributed across the section, and PC 36:2 is enhanced in LE. Positive mode ion images were also obtained for a similar mouse uterine tissue section using high-resolution capillary-based nano-DESI MSI for comparison with iMFP (FIG. 16 panel B). This comparison indicates that iMFP provides ion images, which are in good agreement with the best-performing capillary-based nano-DESI probe. See R. Yin, K. E. Burnum-Johnson, X. Sun, S. K. Dey, J. Laskin, Nat. Protoc. 2019, 14, 3445-3470, the content of which is incorporated by reference herein in its entirety.

The spatial resolution is another important parameter describing the performance of MSI techniques. In this study, we used the “80-20” rule (S. L. Luxembourg, T. H. Mize, L. A. McDonnell, R. M. Heeren, Anal. Chem. 2004, 76, 5339-5344, the content of which is incorporated by reference herein in its entirety) to estimate the upper limit of the spatial resolution. In this approach, the spatial resolution is calculated from the distance, across which the abundance of the sharpest features in the image changes between 20% and 80%. Accurate measurement of the spatial resolution requires the presence of steep chemical gradients in the sample. We used the ion image of SM 34:1 (FIG. 21 panel A), which shows distinct localization in the tissue. FIG. 21 panel B shows a line profile for SM 34:1 extracted along the direction indicated by the white line in FIG. 21 panel A. The line profile crosses the boundaries of different cell types and contains multiple peaks. We estimate the spatial resolution from the transition regions between LE (or GE) and stroma (FIG. 21 panel C) to be in a range of 22 to 25 μmas shown in FIG. 21 panel D. We conservatively estimate that the upper limit of the spatial resolution obtained in this study is 25 μm.

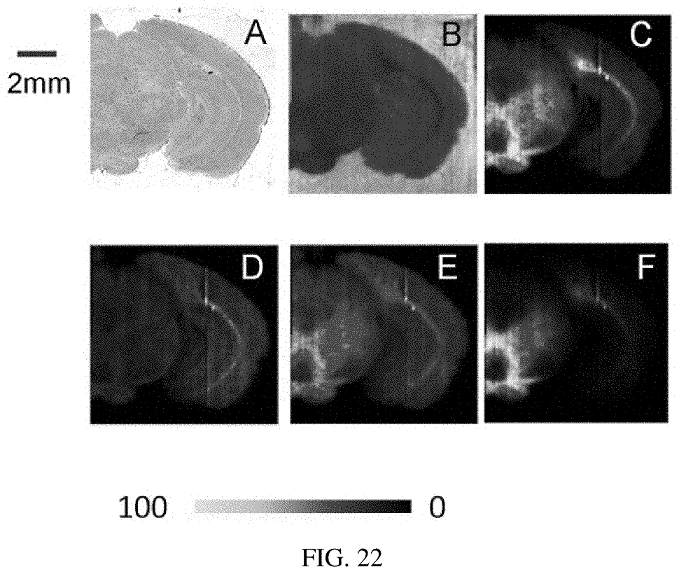

To further verify the robustness and stability of the iMFP for MSI experiments, we acquired ion images for a fairly large mouse brain tissue section (7.7 mm×5.5 mm). The results are shown in FIG. 22 panels A-F. In this experiment, we used the same conditions as in FIG. 16 panels A-B but increased the scan rate to 40 μmis, which allowed us to acquire the image in 4 hrs (80 lines×3 minutes/line). Representative ion images of sodium adducts ([M+Na]+) of phospholipids in mouse brain tissue are shown in FIG. 22 panels B-F. Consistent with our previous study (J. Laskin, B. S. Heath, P. J. Roach, L. Cazares, 0. J. Semmes, Anal. Chem. 2012, 84, 141-148; and I. Lanekoff, S. L. Stevens, M. P. Stenzel-Poore, J. Laskin, Analyst 2014, 139, 3528-3532, the content of each of which is incorporated by reference herein in its entirety) we observed that matrix effects play an important role in the imaging of brain tissue sections. Ion suppression results in a non-uniform distribution of the LPC 19:0 internal standard used in this experiment (FIG. 22 panel B). Good-quality ion images of phospholipids (FIG. 22 panels C-F) confirm the stability of the probe over the course of a 4 hr-long experiment.

This Example and the data herein show that the incorporation of the iMFP into nano-DESI MSI is a very good strategy for making this imaging technique broadly accessible. We demonstrate the sensitivity and robust operation of the iMFP for imaging of biological tissues. Similar to the capillary-based nano-DESI MSI, the composition of the extraction solvent used in the iMFP can be adjusted to facilitate the detection of different classes of molecules.

Furthermore, the use of solvents containing internal standards is advantageous for evaluating and compensating for matrix effects in iMFP MSI. The integrated device is easy to align in front of a mass spectrometer and easy to operate making it attractive for commercialization. Experiments performed over the course of several months indicate that the same iMFP device can be re-used many times.

In summary, we have developed a new integrated microfluidic nano-DESI MSI probe, iMFP, and evaluated its performance for imaging of biological tissues. We optimized the geometry of the device to enable efficient extraction of molecules from the sample and transfer to a mass spectrometer and provide stable ion signals. We demonstrate a comparable performance of the iMFP and the best capillary-based nano-DESI MSI and a spatial resolution of better than 25 μm. The device is compatible with any mass spectrometer making it broadly applicable to different types of MSI experiments. We envision that the probe will become an inexpensive “consumable”, which will advance its dissemination to the broad scientific community. Also contemplated herein is improved spatial resolution and coupling of the iMFP to high-performance mass spectrometers capable of operating at high repetition rates, which will speed up the image acquisition process. The iMFP will advance the capabilities of MSI in biological and clinical research.

### Example 2: Materials and Methods

Reagents, Materials, and Equipment

Methanol and Omnisolv LC-MS grade water for preparing work solvent was purchased from Millipore Sigma (Burlington, Mass.). LPC19:0 (Avanti Polar Lipids, cat. No. 855776P) is used as an internal standard in the work. Soda-lime microscope slides (LxW 75 mm×50 mm, Thick 0.9-1.1 mm; Corning) used as substrate wafer and cover wafer. AZ1518 positive photoresist was obtained from Clariant Corp (Somerville, N.J.). All other chemicals used were obtained from J. T. Baker (Phillipsburg, N.J.). Chrome layers were deposited with an E-Beam Evaporator from CHA Industries (Fremont, Calif.). The UV photolithography processes are performed using MJB3 mask aligner from Suss Microtech (Waterbury, Vt.). The photoresist spin coating used 6808P Spin Coater (Specialty Coating Systems, IN 46278 USA). A model P-7 Profilometer (KLA Corporation, Milpitas, Calif.) was used to measure the depth and width of microfluidic channels. High-temperature bonding for glass microfluidic chips was performed in a programmable furnace (The Mellen Company, Concord, N.H. 03301, USA.). The chips fabrication process is completed in the cleanroom of the Birck Nanotechnology Center at Purdue University except for the high-temperature bonding step.

Solvent Preparation

Prepare 5 mL of 9:1 (v/v) methanol/water mixture in a 20 mL scintillation vial. Add 10 μM of 200 μM LPC 19:0, an internal standard for positive mode experiments into the vial and vortex the solution vigorously. The final concentration of LPC 19:0 is 400 nM. The solvent can be stored for a week at room temperature or several months at −20° C. It needs to be diluted to the desired concentration before the solvent is used.

Biological Tissues

Tissue sections were prepared according to the previously described methods. [1] Briefly, an uterus was collected from a 4 days pregnant mouse, frozen in liquid nitrogen, and sliced to a series of sections with a thickness of 10 μm. Brain tissue was collected from a healthy adult mouse. The tissue was embedded in carboxymethyl cellulose solution, snap-frozen, and sectioned at 10 μm thickness. The uterine and brain sections were stored at −80° C. prior to imaging. Mice were housed in negative-air flow polycarbonate cages with corn cob beddings. All the mice were maintained on a C57BL6 mixed background, and housed in the vivarium at the Cincinnati Children's Hospital Medical Center according to NIH and institutional guidelines for laboratory animals. They were provided with double distilled autoclaved water ad libitum and rodent diet (LabDiet 5010). The study was approved by the Cincinnati Children's Hospital Research Foundation Institutional Animal Care and Use Committee. All animal use and handling in this work followed the Guide for the Care and Use of Laboratory Animals (NIH).

IV. Design and Fabrication of the Glass Microfluidic Chip and the Integrated Microfluidic Probe (5 iMFP). Standard photolithography, chemical wet etching, and high-temperature bonding techniques were used to fabricate glass microfluidic chips. The general steps refer to the description in these reports (C. Iliescu, H. Taylor, M. Avram, J. Miao, S. Franssila, Biomicrofluidics 2012, 6, 016505 (1-16); W. Gopel, J. Hesse, J. N. Zemel, Sensors: a comprehensive survey, 1989; and M. Stjemstrom, J. Roeraade, J. Micromech. Microeng. 1998, 8, 33-38, the content of each of which is incorporated by reference herein in its entirety). Some steps such as the method of the etching solution and the etching time were further optimized, the procedures to fabricate the entire chip are as follows:

(1) The fabrication of the photomask: blank photomasks are acquired from Nanofilm (Nanofilm.com, Westlake Village, Calif.) with 500 nm thick AZ1518 positive photoresist and 100 nm thick chrome on soda-lime glass plates (4″×4″, 0.090″ thick). The pattern which was designed in KLayout (www.klayout.de) with GDSII format was transferred to the photomasks using a 405 nm wavelength laser in Heidelberg MLA150 maskless aligner. The photomasks were developed in Megaposit MF26A (DOW, Capitol Scientific) and etched in CR-16 chrome etchant (VWR).

(2) The glass microfluidic chips are fabricated with the following procedures: Corning® soda-lime microscope slides as substrate wafer and the cover wafer is used to fabricate the glass chips. Glass substrate wafers and glass cover wafers are washed using an ultrasonic cleaner with toluene, acetone, isopropanol, methanol, and deionized (DI) water (18.2 MU, Milli-Q, Millipore) sequentially, and dried with N2. Putting the substrate wafer into piranha solution for soaking it for 30 minutes, then rinsing with DI water, and dried by N2. 150 nm of Cr layer was deposited on the glass substrate surface. After the photoresist is spined to a thickness of ˜1 μm on the Cr surface and baked using a hot plate at 100° C. for 5 mins, then the pattern was formed on the glass substrate with a conventional UV photolithographic method. The exposed areas were developed by immersing the substrate into a developing solution for 2 mins, the exposed chrome layer was removed with chrome etchant. Glass etching was performed in a vigorously stirred hydrofluoric acid buffer solution (30% HF, 35% NH4F, 5% HCl, and 30% H2O) at room temperature. The 15 μm-wide microchannels patterned on the glass are etched for 35 mins to generate a depth of ˜25 μm and final width of ˜40 μm via measure by KLA P7 stylus profiler. The size of channels can be controlled by corrosion time. After all photoresist and chrome layer on the surface of the substrate was removed, the substrate wafer with the channels and the cover wafer was immersed in piranha solution for 30 mins, then the high-temperature bonding was performed at rising/drop gradient 10° C./min is used, maintain 590° C. for 3 hrs.

(3) Fabrication of the iMFP. Subsequent multistep grinding and polishing are used to fabricate the integrated nanospray emitter and sampling port. The grinding and polishing are performed using electric polishing tools and different grit sandpaper (from 800-grit to 1500-grit,). Electrospray emitter and sample port were formed are carried out under the observation of a microscope. The final thickness of the microfluidic probe is ˜Imm, the diameter of the nanospray emitter tip is ˜50 μm, the width of the sample extraction port is about 50 μm. The final step is that the solvent channel and fused silica capillary were connected using steel-reinforced epoxy resin (J-B Weld Company, LLC, Sulphur Springs, Tex.), and auxiliary adhesion by Dent Light Cured Dental Block Out Resin (Bargin dental, San Dimas, Calif.).

The iMFP-Based Nano-DESI Imaging Platform

The integrated microfluidic nano-DESI MS imaging platform comprises a syringe pump (Legato 180, KD Scientific) with 2.5 mL syringe (Model 1002 LTN SYR, Hamilton, cat. No. 81416) for solvent delivery, a micro-positioner, XYZ motorized stages, a sample holder, two Dino-Lite digital microscopes (Dino-Lite Digital Microscope, cat. No. AM4515T8) are used for monitoring the nano-DESI probe during imaging experiments. One of them is focused on the sample extraction port and another is used to monitor the nanospray emitter tip and MS inlet. The iMFP is fixed on a positioner with a distance of ˜0.5 mm between the nanospray emitter tip and the MS inlet orifice. The spray voltage of +3.0 kV is applied to a 10 cm long fused-silica capillary (50 μm id), which was connected to the solvent channel through a high-voltage cable. A 10-MO resistor is integrated into the high-voltage cable to avoid potential electric shock induced by a high spray voltage. A microscope glass slide containing tissue sections is mounted onto the sample holder. The extraction solvent is transported by a syringe pump connecting to the capillary by PEEK tube. The dissolved sample is delivered to the mass spectrometer and ionized by applying a voltage of 3000V between the tip of the iMFP and mass spectrometer inlet.

Parameters Setup of Mass Spectrometry Imaging Experiments

All experiments with mouse uterine tissue and mouse brain tissue sections were performed on a Q Exactive HF-X mass spectrometer (Thermo Fisher Scientific, Waltham, Mass.). A high voltage of +3.0 kV and an RF Funnel voltage of +100 V were applied in positive mode, mass spectra were acquired in the range of m/z 133-2000 with a mass resolution of 60,000 at m/z 200; AGC was set at 1×10⁶ and the maximum injection time was 200 ms; the heated capillary was held at 250° C.

Visualize the Raw Files Using MS/QuickView

MSI QuickView is a software customized for converting mass spectrometry datum to visualized ion images. Regarding the detailed description for the function of the software can be found in our previous work (I. Lanekoff, B. S. Heath, A. Liyu, M. Thomas, J. P. Carson, J. Laskin, Anal. Chem. 2012, 84, 8351-8356, the content of which is incorporated by reference herein in its entirety) The steps are simply summarized as follows: 1) loading the raw files in this software; 2) defining the aspect ratio of the sampled area; 3) uploading a mass list to be visualized; 4) generating ion images for each mass spectrum; 5) save the image to a folder. In this experiment, the positive mode acquired from mouse uterine tissue sections and mouse brain tissue sections should be processed and visualized. The ion images of lipids can be normalized to either the TIC or signal of the internal standard (LPC 19:0 for the internal standard of positive mode).

### Plastic Microfluidic Probe

In certain circumstances, the microfluidic probe may be fabricated with plastic to advantageously enable an enhanced efficiency for the time and/or the cost to manufacture the microfluidic probe. More specifically, the plastic microfluidic probe may be easily fabricated using wire imprinting and thermal bonding. Desirably, the plastic microfluidic probe may be used for imaging of biological tissues with high resolution and throughput. For instance, the plastic microfluidic probe may be used for tissue imaging with a spatial resolution around 25 μm. Further, the plastic microfluidic probe may also be used for mapping biomolecules in biological samples with a subcellular resolution.

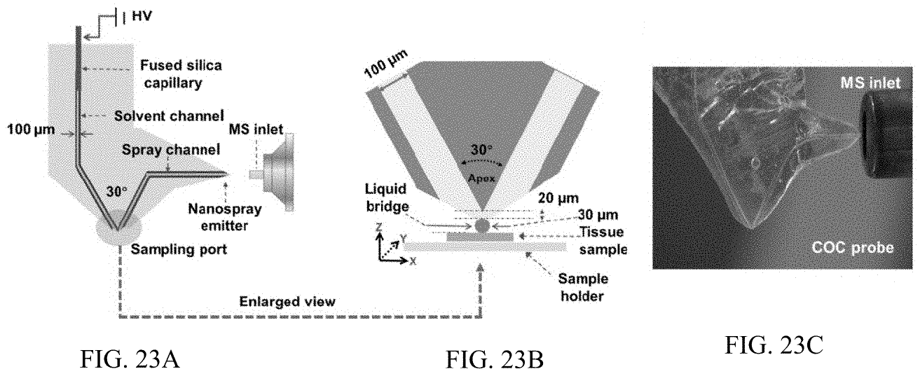

In certain circumstances, as shown in FIG. 23A, the plastic microfluidic probe includes a primary solvent channel and a spray channel intersecting at a fixed orientation relative to each other at an opening in a tip of the probe. The probe may be constructed from plastic. As shown in FIG. 23B, the probe may be operated to create a liquid bridge at the opening between the primary channel, the spray channel, and a surface when the opening is located proximal to the surface and a liquid is flowed through the primary channel into the spray channel across the opening. The probe may also include a nanospray emitter in fluid communication with the opening via the spray channel.

In certain circumstances, the plastic microfluidic probe may be manufactured using various thermoplastics materials. For instance, various suitable thermoplastic materials are provided in Table 1 below:

TABLE 1
Potential thermoplastic/Polymer substrate for the
fabrication of the integrated microfluidic probes

| Wire imprinting method | | | Silicon mold method | | |
|---|---|---|---|---|---|
| | Thermal | | | Thermal | |
| Thermoplastic type | property^{(a)} | | Thermoplastic type | property | |
| The family of cyclic olefin | 70-155° | C. | The family of cyclic olefin | 70-155° | C. |
| polymers: | | | polymers: | | |
| (1) Cyclic olefin | | | (1) Cyclic olefin | | |
| copolymer (COC) | | | copolymer (COC) | | |
| (2) Cyclic olefin polymer | | | (2) Cyclic olefin polymer | | |
| (COP), and | | | (COP), and | | |
| (3) Cyclic block | | | (3) Cyclic block | | |
| copolymer (CBC)) | | | copolymer (CBC)) | | |
| Polymethylmethacrylate | 85-105° | C. | Polymethylmethacrylate | 85-105° | C. |
| (PMMA) | | | (PMMA) | | |
| Polycarbonate (PC) | 140~150° | C. | Polycarbonate (PC) | 140~150° | C. |
| Polystyrene (PS) | 90~100° | C. | Polystyrene (PS) | 90~100° | C. |
| Polyvinyl chloride (PVC) | ~80° | C. | Polyvinyl chloride (PVC), | ~80° | C. |
| Polyethylene terephthalate | ~80° | C. | Polyethylene terephthalate | ~80° | C. |
| glycol (PETG) | | | glycol (PETG) | | |
| Polyethylene (PE) | 98-115° | C. | Polyethylene (PE) | 98-115° | C. |
| Polyimide (PI) | ~388° | C. | Polyimide (PI) | ~388° | C. |
| Styrene copolymer | 100-200° | C. | Styrene copolymer | 100-200° | C. |
| Parylene C | 80-290° | C. | Parylene C | 80-290° | C. |
| Polytetrafluoroethylene | 115° | C. | Polytetrafluoroethylene | 115° | C. |
| (PTFE or Teflon ®). | | | (PTFE or Teflon ®). | | |
| | | | Polydimethylsilonxane | ~80° | C. |
| | | | (PDMS) | | |

| | |
|---|---|
| Epoxies (SU-8, a Versatile | 50° C.-55° C., |
| Photoresist) | uncross- |
| | linked; >200°, |
| | cross-linked |

^{(a)}Thermal property is determined based thermoplastic glass transition (Tg) temperature and on the PDMS or SU-8 curing temperature.

In a specific example, the plastic microfluidic probe may be manufactured using cyclic olefin copolymer (COC). COC provides the advantages of biocompatibility, UV transparency, chemical resistance, tunable mechanical stiffness, and convenient prototyping outside clean-room environments. In particular, the COC microfluidic nano-DESI probe may offer the advantages of robustness, sensitivity, and ease of use, which will make the technique attractive for a broad range of applications. One skilled in the art may select other suitable thermoplastic materials to construct the plastic microfluidic probe, within the scope of the present disclosure.

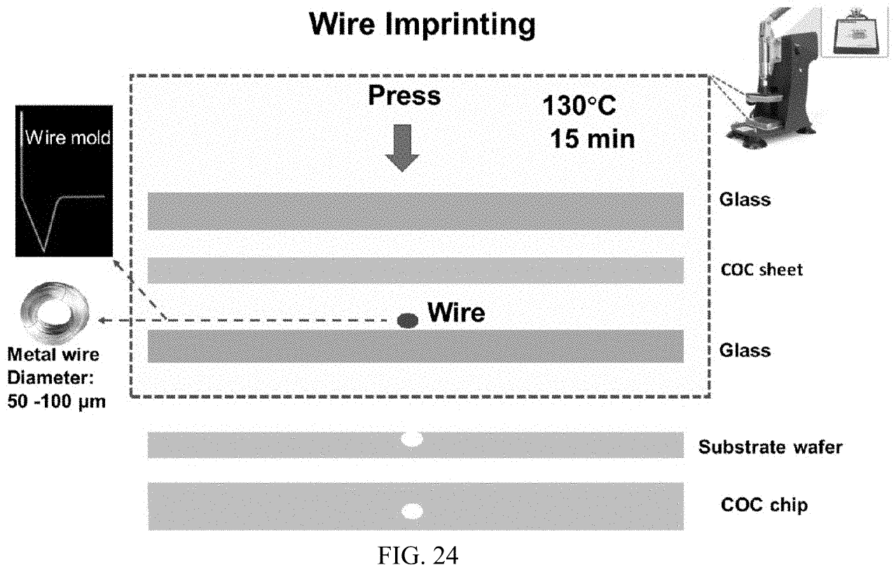

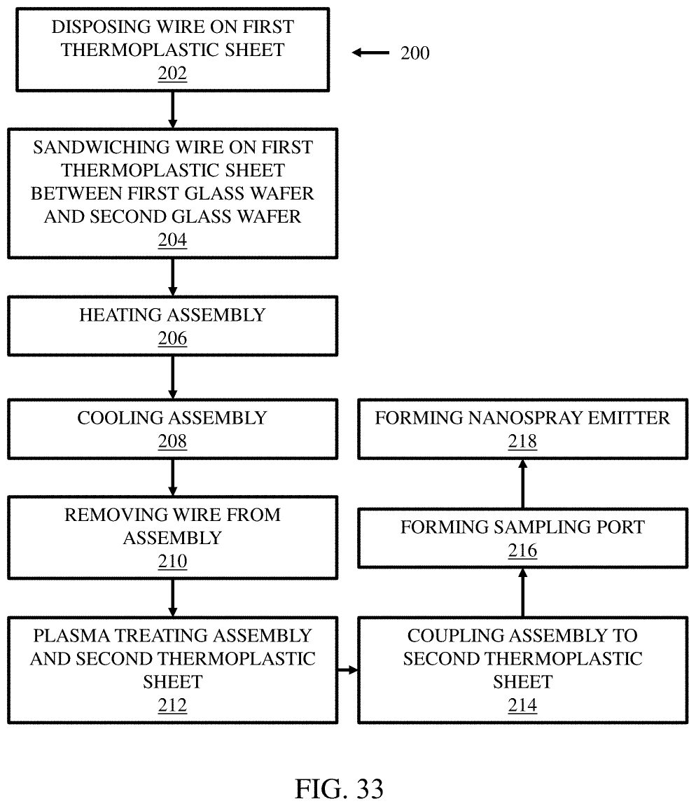

The fabrication of the plastic microfluidic probe may include various materials and a variety of methods. In certain circumstances, the plastic microfluidic probe may be fabricated by using photolithography and/or dry etching equipment to emboss a plastic substrate onto a three-dimensional channel mold formed on a silicon wafer. This silicon mold may be repeatedly used to fabricate a plurality of plastic microfluidic probes simultaneously. In a specific example, as shown in FIGS. 24 and 33, a first method 200 of fabricating the plastic microfluidic probe may include placing a metal wire on a COC sheet, which is then sandwiched between two glass wafers. As a specific example, the metal wire may be a copper wire. More specifically, the metal wire may be a 100 μm diameter copper wire, which was found to be well suited for the fabrication of the plastic microfluidic probe with a stable sampling port. The assembly may then be heated. More specifically, the assembly may be placed in a double-sided hot plate or oven at 130° C. for fifteen minutes. Afterwards, the assembly may be cooled to room temperature. The wire may be removed leaving an empty channel. In a specific example, the channel may have a final channel width of around 5 μm to around 300 μm. In a more specific example, the channel width may be around 50 μm to around 150 μm. In an even more specific example, the channel width may be around 60 μm. The resulting COC channel sheet and a blank COC sheet may undergo a dry etching process or a plasma treatment process for around five minutes. The sheets may then be disposed together and sandwiched between two glass wafers for thermal bonding at 130° C. for fifteen minutes. In a specific example, the sheets may be thermally bonded via a hot press. Formed chip edges may then be sheared and polished to form a microfluidic probe with a sampling port and nanospray emitter. In a specific example, the sampling port and the nanospray emitter may be trimmed out with scissors.

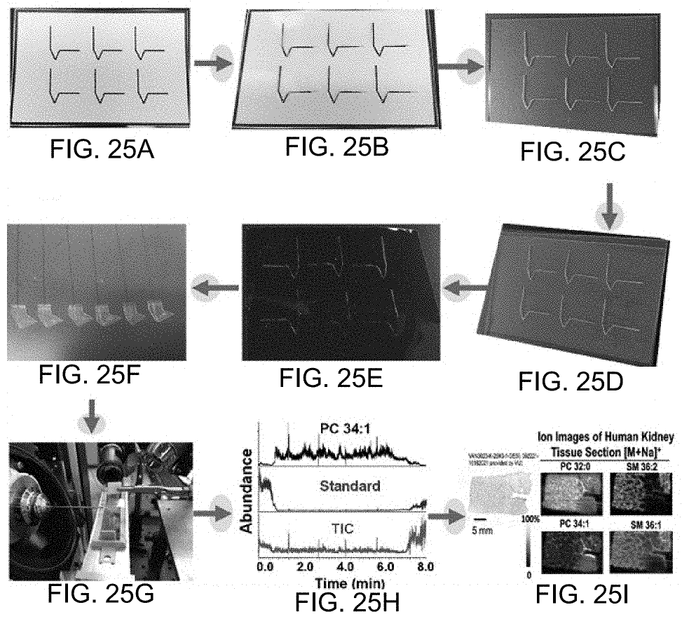

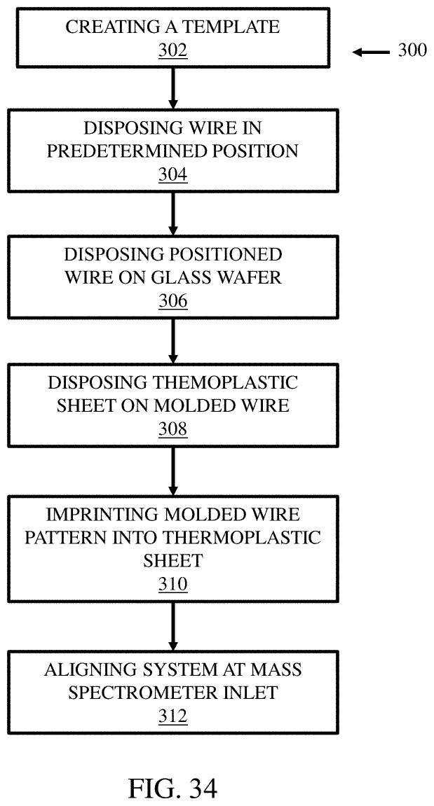

In certain circumstances, a plurality of plastic microfluidic probes may be fabricated simultaneously. For instance, as shown in FIGS. 25A-25G and FIG. 34, a second method 300 of fabricating the plastic microfluidic probe may include creating a template. In a specific example, the template may be constructed from paper. Next, a metal wire may be arranged in predetermined position on the on the template to form a mold. In a specific example, the metal wire may include a plurality of metal wires, which may be used to form a plurality of plastic microfluidic probes from a single thermoplastic sheet. The molded wire may be placed on a glass wafer. Then, a COC sheet may be placed on the wire molds. A predetermined COC probe pattern may be imprinted, thus forming an individual plastic microfluidic probe. In a specific instance, the imprinting method may include utilizing a hot press. In certain circumstances, the assembled plastic microfluidic probes may be aligned at a mass spectrometer inlet. It should be appreciated the order of the steps of either the first method 200 or the second method 300 may be rearranged as desired.

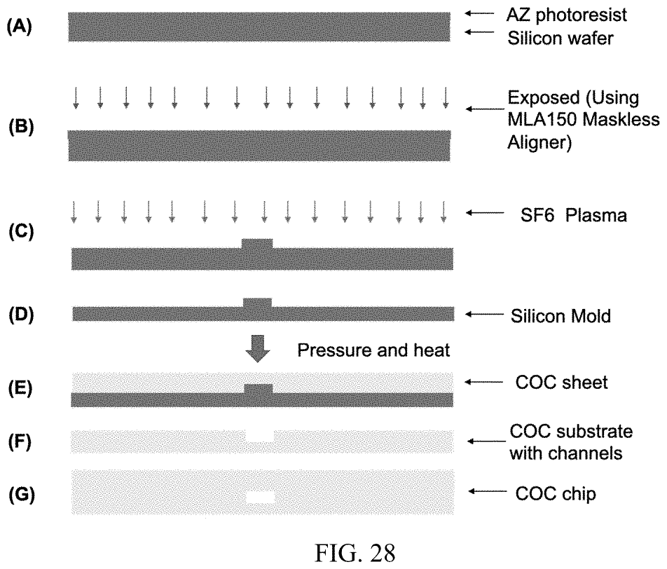

In a specific, non-limiting example of the method 200, the mold may be fabricated from a silicon wafer. In more specific example, the silicon wafer may be around six inches. As shown in FIG. 28, a layer of photoresist may be spin-coated onto the surface of the silicon wafer and subsequently exposed to the UV light, such as using a MLA150 Maskless Aligner. The photoresist may then be developed, revealing the transferred probe pattern. Next, the photoresist may be removed from substantially all areas except for that defining the channels of the probe. The wafer may then be etched by an advanced silicon etching (ASE) system. The silicon wafer may be etched to a depth of ˜100 μm using the ASE. Silicon may be etched in all areas around the channel, producing a channel structure that is raised as a three-dimensional rectangle. The photoresist may be removed with acetone. Then, the mold may be sequentially rinsed in isopropanol, methanol, and distilled water. This silicon mold may be used to emboss channels on a plastic substrate. A skilled artisan may select other suitable methods and materials to form the silicon mold, within the scope of the present disclosure.

In certain circumstances, the plastic microfluidic probe may include a chip having an emitter, a sample probe opening, and a channel propelling the solvent to and from the sample. As shown in FIG. 23C, the emitter may include a sharp point, which may be disposed substantially adjacent to and/or in front of a mass spectrometer inlet. The sample probe opening may be finely-polished and configured to be brought in contact with a sample. In a specific example, the chip may include a plurality of channels propelling the solvent to and from the sample. In an even more specific example, the channel may include the primary channel and the spray channel. The primary and spray channels may meet at an opening in the sample probe tip at an apex, or otherwise known as a fixed angle. In a specific example, the fixed angle may be greater than zero degrees but less than one-hundred and fifty degrees. In more specific example, the fixed angle may be between around twenty degrees and around sixty degrees. In an even more specific example, the fixed angle may be around thirty degrees. The parameters of the chip design may be optimized to enhance the control of a formed liquid bridge is obtained when the primary channel and the spray channel are arranged as shown in FIGS. 23A-23B. One aspect of the plastic microfluidic probe is the apex, which is the junction of the primary channel and spray channel. Through a multistep shearing and polishing of the sampling port, the apex may be positioned in such a way that it is brought in direct contact with the sample surface when the probe lands on a sample surface. Advantageously, this geometry may minimize the size of the liquid bridge while maintaining its stability, as shown in FIG. 23B. Liquid extraction of molecules into the liquid bridge is followed by their soft ionization at the inlet.

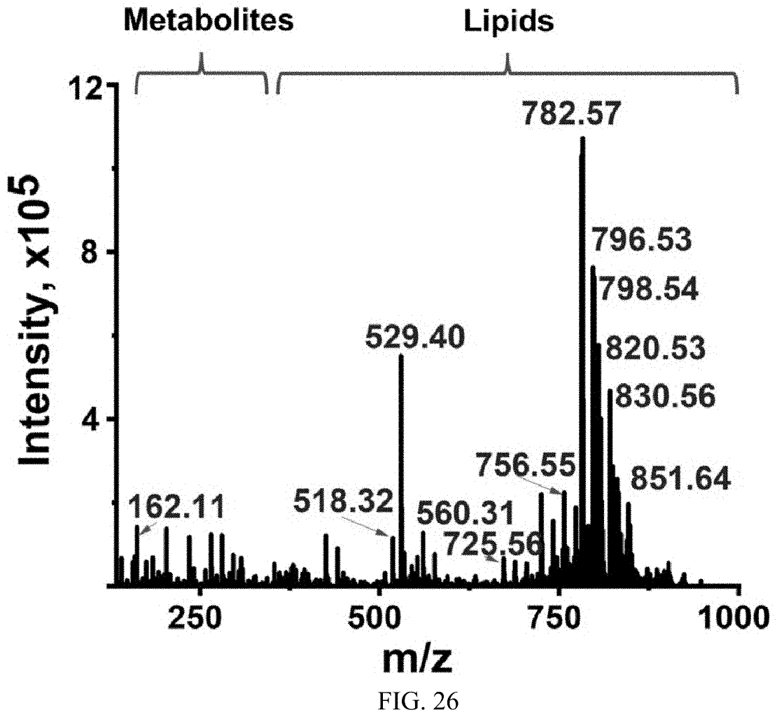

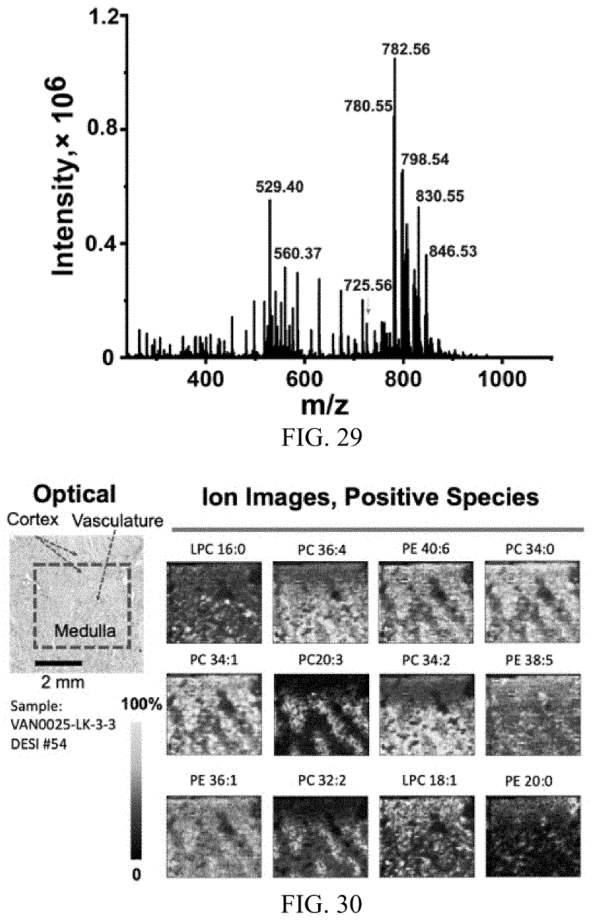

In an effort to test the capabilities of the plastic microfluidic probe, the performance of the COC probes was evaluated by imaging mouse uterine tissue sections. This is a commonly used sample for the evaluation of high-resolution nano-DESI MSI probes, which contains multiple cell types with distinct chemical gradients in a small area of ˜2 mm×2 mm. Tissue images were obtained with high sensitivity and a spatial resolution of better than 25 μm. Ion images obtained using the plastic microfluidic probe are in perfect agreement with ion images obtained in previous studies using both capillary-based and glass microfluidic probes. Moreover, the plastic microfluidic probe was used to perform high-throughput MSI of mouse brain tissue sections at a scan rate of 0.2 mm/s. The plastic microfluidic probe may be manufactured more inexpensively and easier to fabricate compared to known probes. The plastic microfluidic probe may provide a comparable sensitivity and spatial resolution to the glass iMFP. The plastic microfluidic probe may also be easier to couple with shear force microscopy which is important for imaging with higher spatial resolution. A single scan positive mode nano-DESI spectrum representing a signal in one pixel of an image from a human kidney tissue sample was obtained using a Q-Exactive HFX mass spectrometer, as shown in FIG. 26 and FIG. 29. The signal-to-noise ratio of ˜1000 was obtained for the most abundant lipid peak, which is comparable or better than the signal obtained using glass iMFP. It should be appreciated that this experimental scan is illustrative of the enhanced capabilities of the plastic microfluidic probe, however, it should not be relied on to limit the capabilities of the plastic microfluidic probe. A single-pixel mass spectrum shows high S/N obtained using the plastic microfluidic probe. Desirably, high spatial resolution enables accurate localization of lipids and metabolites to different anatomical regions of the tissue.

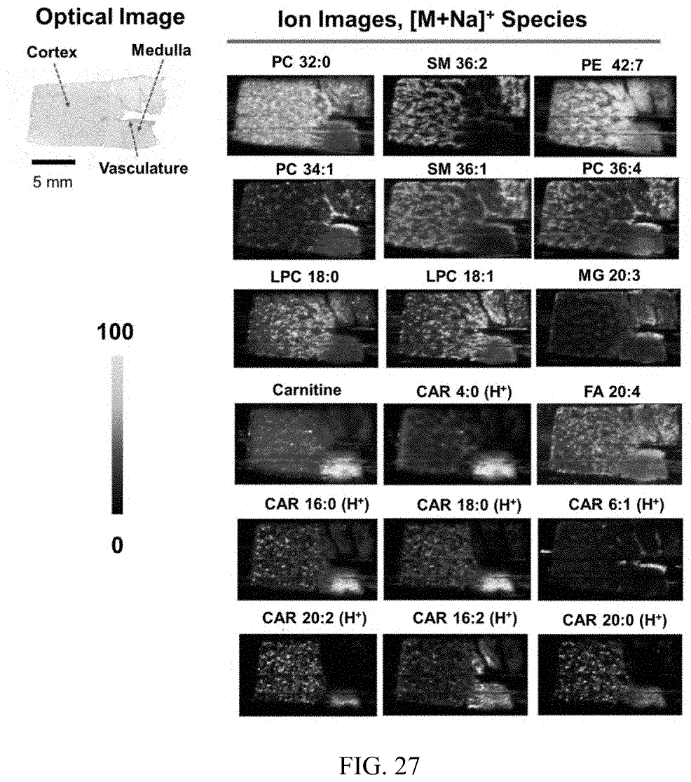

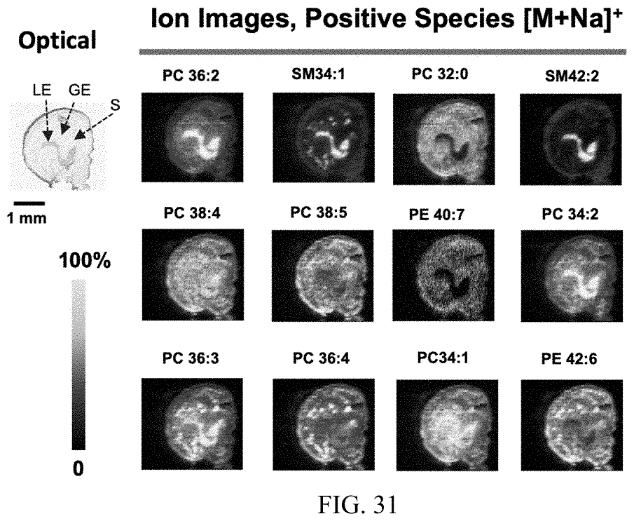

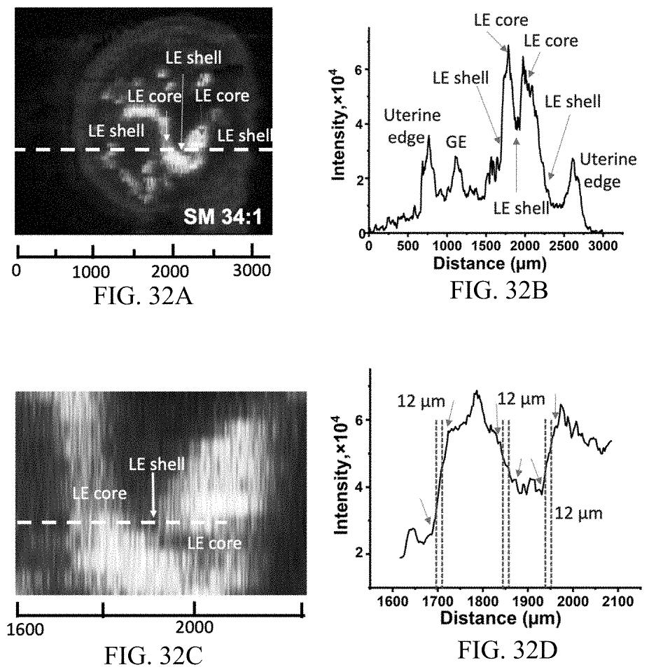

With continued reference to the non-limiting experimental study, representative positive mode ion images of endogenous lipids and metabolites in human kidney tissues are shown in FIG. 27 and FIG. 30, illustrating several distinct distributions across the tissue. PC 32:0, LPC 18:0, LPC 18:1 are enhanced in the cortex; PC 34:1 shows a substantial enhancement in glomeruli; PC 36:4, SM 36:1 show enhancement in the tissue surrounding glomeruli and tubules. Specifically, SM 36:2 is suppressed in the transition region between cortex and medulla. Each metabolite shows a unique spatial localization, except for FA 20:4, which showed an even distribution in both cortex and medulla. As shown in FIG. 31, representative ion images of endogenous molecules acquired in mouse uterine tissue were obtained. The ion images were normalized to TIC. With further reference to FIG. 31, the abbreviations include Luminal epithelium (LE), Glandular epithelial cells (GE), Stroma that surrounds LE and GE. To estimate the spatial resolution of the plastic microfluidic probe fabricated by the silicon mold, the ion image of SM 34:1 from FIG. 31 was enlarged in FIG. 32A. In FIG. 32A, a white line indicates the location of the line profile shown in FIG. 32B. FIG. 32B provides a representative line profile of SM 34:1 along the white line in FIG. 32A. The ion signal is normalized to the TIC. As shown in FIG. 32C, an expanded view of the core and boundary region in LE is provided. With reference to FIG. 32D, a partial line profile was extracted along the white line shown in FIG. 32C. The spatial resolution was ˜12 μm. The arrows indicate the maximum (100%) and minimum (0%) values in FIG. 32D. The dashed lines indicate the positions at which the SM 34:1 signal is at 20% and 80% of its minimum and maximum value, respectively, for a specific region. Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions, and methods can be made within the scope of the present technology, with substantially similar results.

What is claimed is:

1. A system for analyzing a sample on a surface, the system comprising:
a probe comprising a primary channel and a spray channel intersecting at a fixed orientation relative to each other at an opening in a tip of the probe, the probe is constructed from a plastic material, wherein the probe is operable to create a liquid bridge at the opening between the primary channel, the spray channel, and the surface where the opening is located proximal to the surface and a liquid is flowed through the primary channel into the spray channel across the opening; and
a nanospray emitter in fluid communication with the opening via the spray channel.

2. The system of claim 1, wherein the plastic material is a thermoplastic material.

3. The system of claim 2, wherein the thermoplastic material is at least one of cyclic olefin copolymer, cyclic olefin polymer, cyclic block copolymer, polymethylmethacrylate, polycarbonate, polystyrene, polyvinyl chloride, polyethylene terephthalate glycol, polyethylene, polyimide, styrene copolymer, parylene C, polytetrafluoroethylene, polydimethylsiloxane, and epoxies.

4. The system of claim 3, wherein the thermoplastic material consists essentially of cyclic olefin copolymer.

5. The system of claim 1, wherein the metal wire is a copper wire.

6. The system of claim 1, wherein the metal wire is around 100 μm in diameter.

7. A microfluidic probe for mass spectrometry imaging comprising a system according to claim 1.

8. A first method for fabricating a system for analyzing a sample, the method comprising:
disposing a metal wire on a first thermoplastic sheet;
sandwiching the metal wire on the first thermoplastic sheet between a first glass wafer and a second glass wafer, thus forming an assembly;
heating the assembly;
cooling the assembly;
removing the wire from the assembly, thus forming a channel in the assembly;
plasma treating the assembly and a second thermoplastic sheet; and
coupling the assembly to the second thermoplastic sheet, thus forming the system.

9. The first method of claim 8, wherein the step of heating the assembly includes placing the assembly in one of a double-sided hot plate and an oven.

10. The first method of claim 8, further comprising a step of forming a sampling port on the system.

11. The first method of claim 10, wherein the sampling port is formed by shearing and polishing an edge of the system.

12. The first method of claim 8, further comprising a step of forming a nanospray emitter on the system.

13. The first method of claim 8, wherein the assembly is coupled to the second thermoplastic sheet via a hot press.

14. The first method of claim 12, wherein the nanospray emitter is formed by shearing and polishing an edge of the system.

15. The first method of claim 8, wherein at least one of the first thermoplastic sheet and the second thermoplastic sheet includes a cyclic olefin copolymer material.

16. A second method for fabricating a system for analyzing a sample, the method comprising:
disposing a metal wire in a predetermined position;
disposing the positioned metal wire on a glass wafer, thus forming a molded metal wire pattern;
disposing a thermoplastic sheet on the molded metal wire; and
imprinting the molded metal wire pattern into the thermoplastic sheet, thus forming the system.

17. The second method of claim 16, wherein the molded metal wire pattern is imprinted into the thermoplastic sheet via a hot press.

18. The second method of claim 16, further comprising a step of aligning the system at a mass spectrometer inlet.

19. The second method of claim 16, wherein the metal wire includes a plurality of metal wires, thus forming a plurality of systems with a single thermoplastic sheet.

20. The first method of claim 16, wherein the thermoplastic sheet includes a cyclic olefin copolymer material.
